(19) United States
(12) Patent Application Publication
(10) Pub. No.: US 2025/0379264 A1
(43) Pub. Date: Dec. 11, 2025

(54) Closed-Loop Battery Manufacturing Process Control Via End-of-Line Diagnostic Features

(71) Applicant: THE REGENTS OF THE UNIVERSITY OF MICHIGAN, ANN ARBOR, MI (US)

(72) Inventors: Anna Stefanopoulou, ANN ARBOR, MI (US); Andrew Weng, ANN ARBOR, MI (US); Jason Siegel, ANN ARBOR, MI (US); Greg Less, ANN ARBOR, MI (US)

(21) Appl. No.: 19/232,325

(22) Filed: Jun. 9, 2025

Related U.S. Application Data
(60) Provisional application No. 63/657,169, filed on Jun. 7, 2024.

(51) Int. Cl. H01M 10/42; H01M 4/04; H01M 10/052; H01M 10/054

(52) U.S. Cl. CPC H01M 10/4235; H01M 4/0452; H01M 10/052; H01M 10/054

(57) ABSTRACT

A method is disclosed for manufacturing an electrochemical cell including an anode, an electrolyte, and a cathode including cations that move from the cathode to the anode during charging. The method comprises: (a) obtaining a measurement of an electrochemical feature at a selected time in a formation charging phase for creating the electrochemical cell from a cell structure, wherein the electrochemical feature is other than capacity, resistance, and voltage decay; and (b) maintaining or adjusting, based on the measurement of the electrochemical feature, at least one process parameter of a manufacturing process selected from: a production process for an anode of a later-produced electrochemical cell, a production process for a cathode of the later-produced electrochemical cell, an assembly process for a cell structure of the later-produced electrochemical cell, a filling process for an electrolyte of the later-produced electrochemical cell, and a formation charging process of the later-produced electrochemical cell.

### CROSS-REFERENCES TO RELATED APPLICATIONS

This application is based on, claims benefit of, and claims priority to U.S. Application No. 63/657,169 filed on Jun. 7, 2024, which is hereby incorporated by reference herein in its entirety for all purposes.

### STATEMENT REGARDING FEDERALLY SPONSORED RESEARCH

This invention was made with government support under Award No. 1762247 awarded by the National Science Foundation. The government has certain rights in the invention.

### BACKGROUND OF THE INVENTION

### 1. Field of the Invention

This invention relates to a platform for electrochemical feature extraction during battery formation such that these features can be used to develop smarter upstream process specifications.

### 2. Description of the Related Art

Lowering the cost of new battery factories is paramount for U.S. global competitiveness. Unfortunately, production costs in the U.S. are presently ˜2× higher than those in Asia. Among the major cost drivers is production scrap which can exceed 50% during production ramp and remain above 5% even at steady-state. A central challenge is that new cell manufacturers often lack the knowledge and time to set process specifications relevant to cell performance and lifetime, leading to unnecessary yield losses. Ongoing supply chain volatility further demands adaptive process control measures amidst changing material streams (e.g., electrode materials from a new supplier) which can further decrease yield (e.g., cathode loading out-of-bounds). Cell manufacturers may be throwing away more cells than needed, but lack the tools and understanding to do better.

Cell manufacturers are also missing an opportunity to leverage existing data collected from formation to understand cell performance and lifetime. While manufacturers already measure capacity, resistance, and open circuit voltage (OCV) decay, these measures cannot identify which manufacturing process deviated and the long-term lifetime impact of such deviations. However, leveraging formation data is challenging: more work is needed to design physically relevant diagnostic features and validate their use towards manufacturing process control and lifetime prediction.

What is needed therefore is a platform for electrochemical feature extraction during battery formation such that these features can be used to develop smarter upstream process specifications informed by battery performance, lifetime, and failure.

### SUMMARY OF THE INVENTION

The present disclosure meets the foregoing needs by providing a platform for electrochemical feature extraction during battery formation such that these features can be used to develop smarter upstream process specifications.

In one aspect, the present disclosure provides a method for manufacturing an electrochemical cell including an anode, an electrolyte, and a cathode including cations that move from the cathode to the anode during a charging phase. The method comprises: (a) obtaining a measurement of an electrochemical feature at a selected time in a formation charging phase for creating the electrochemical cell from a cell structure, wherein the electrochemical feature is other than capacity, resistance, and voltage decay; and (b) maintaining or adjusting, based on the measurement of the electrochemical feature, at least one process parameter of a manufacturing process selected from: a production process for an anode of a later-produced electrochemical cell, a production process for a cathode of the later-produced electrochemical cell, an assembly process for a cell structure of the later-produced electrochemical cell, a filling process for an electrolyte of the later-produced electrochemical cell, and a formation charging process of the later-produced electrochemical cell.

In another aspect, the present disclosure provides a method for manufacturing an electrochemical cell including an anode, an electrolyte, and a cathode including cations that move from the cathode to the anode during a charging phase. The method comprises: (a) obtaining a measurement of an electrochemical feature at a selected time in a formation charging phase for creating the electrochemical cell from a cell structure, wherein the electrochemical feature is other than capacity, resistance, and voltage decay; and (b) detecting or ruling out a manufacturing defect, based on the measurement of the electrochemical feature.

In yet another aspect, the present disclosure provides a method for predicting end of life of an electrochemical cell including an anode, an electrolyte, and a cathode including cations that move from the cathode to the anode during a charging phase. The method comprises: (a) obtaining a measurement of an electrochemical feature at a selected time in a formation charging phase for creating the electrochemical cell from a cell structure, wherein the electrochemical feature is other than capacity, resistance, and voltage decay; and (b) determining end of life of the electrochemical cell based on the measurement of the electrochemical feature.

In still another aspect, the present disclosure provides a system for manufacturing an electrochemical cell including an anode, an electrolyte, and a cathode including cations that move from the cathode to the anode during a charging phase, wherein the system comprises: a sensor that generates signals from measurement of an electrochemical feature at a selected time in a formation charging phase for creating the electrochemical cell from a cell structure, wherein the electrochemical feature is other than capacity, resistance, and voltage decay; and a controller in electrical communication with the sensor, the controller executing a program stored in the controller to: (i) receive the signals from measurement of the electrochemical feature, and (ii) maintain or adjust, based on the signals, at least one process parameter of a manufacturing process selected from: a production process for an anode of a later-produced electrochemical cell, a production process for a cathode of the later-produced electrochemical cell, an assembly process for a cell structure of the later-produced electrochemical cell, a filling process for an electrolyte of the later-produced electrochemical cell, and a formation charging process of the later-produced electrochemical cell.

In yet another aspect, the present disclosure provides a system for manufacturing an electrochemical cell including an anode, an electrolyte, and a cathode including cations that move from the cathode to the anode during a charging phase, wherein the system comprises: a sensor that generates signals from measurement of an electrochemical feature at a selected time in a formation charging phase for creating the electrochemical cell from a cell structure, wherein the electrochemical feature is other than capacity, resistance, and voltage decay; and a controller in electrical communication with the sensor, the controller executing a program stored in the controller to: (i) obtain a measurement of an electrochemical feature at a selected time in a formation charging phase for creating the electrochemical cell from a cell structure, wherein the electrochemical feature is other than capacity, resistance, and voltage decay; and (ii) detect or rule out a manufacturing defect, based on the signals.

It is an advantage of the present disclosure to provide a platform for electrochemical feature extraction during battery formation, the last step in battery manufacturing. These features are used to develop smarter upstream process specifications informed by battery performance, lifetime, and failure. The platform is “sensor-free”, i.e., it utilizes electrical data already collected from standard formation cycling equipment and thus bears no additional capital costs. The platform sets a foundation for enabling closed-loop cell manufacturing process specifications for improving battery costs without compromising performance and reliability.

It is another advantage of the present disclosure to provide physics-informed battery formation models that can help improve end-of-line diagnostics by improving the interpretability of formation features and identifying design rules for formation protocol optimization. We showed how a formation model can enable a rich set of state predictions. The model can be used to develop adaptive formation protocols and enable online, closed-loop manufacturing process control for future factories.

It is another advantage of the present disclosure to provide a method for embedding diagnostic features directly inside the formation protocol. Changes in these diagnostic features indicate deviations in upstream manufacturing process parameters such as in electrode coating and electrolyte filling. These features include, without limitation, the negative to positive capacity ratio (NPR), the lithium consumed during formation (Q_{SEI}), and electrode loadings (Qₙ and Qₚ), all of which are critical cell design parameters affecting cell performance and lifetime. It is demonstrated that these features can detect industrially relevant changes to critical process parameters and for multiple representative chemistries. In one embodiment, the diagnostic features are augmented to enable the detection of manufacturing defects (e.g., metal contamination, moisture) which are significant sources of yield loss. The sensitivity of these features towards defect detection is quantified experimentally. In one embodiment, the diagnostic features enable the identification of internal shorts. The formation aging step, which can take up to three weeks due to the long time needed to detect subtle internal shorts from monitoring open circuit voltage (OCV) decay, can thus be shortened or may no longer be needed. The diagnostic features may thus enable speeding up the overall formation process by reducing the time needed for formation aging.

It is another advantage of the present disclosure to provide a method to define end-of-line specifications informed by long-term cell lifetime and reliability. These specifications are developed based on the diagnostic features obtained from the methods of this disclosure. We experimentally demonstrate that features are connected to long-term cell performance by developing a design of experiments comprising pouch cells using varying process parameters (e.g., electrode loadings, calendaring pressure, electrolyte formulation, varying types and levels of defects). These cells can undergo customized formation protocols that enable the extraction of the electrochemical features obtained from the methods of this disclosure. The cells can then undergo long-term cycle life testing using representative test profiles. The completed dataset can be used to identify which process parameters or defects are most impactful to cell lifetime. The dataset can further inform which diagnostic features are the most sensitive to process parameter changes and lifetime.

It is another advantage of the present disclosure to provide a method for developing adaptive formation protocols to compensate for upstream process drifts, e.g., due to changes in raw material supply (e.g., recycled cathode material or material from a different supplier) and factory environmental factors (e.g., humidity). We thus demonstrate the usage of tailored formation protocols to achieve certain performance and lifetime targets. The adaptive formation protocol can also reduce initial cell variability and lower scrap rates.

These and other features, aspects, and advantages of the present invention will become better understood upon consideration of the following detailed description, drawings, and appended claims.

### BRIEF DESCRIPTION OF THE DRAWINGS

FIG. 1 shows smart battery formation according to a non-limiting embodiment of the present disclosure.

FIG. 2 shows a low-cost fixture platform for measuring cell thickness expansion based on inductive sensing for use in smart battery formation according to a non-limiting embodiment of the present disclosure.

FIG. 3 shows non-destructive formation features (FFs) extraction via differential voltage analysis [Ref. 2]. Panel (a) shows a method for analyzing a full cell C/20 charge voltage curve (black) to automatically extract electrode capacities (Q⁺, Q⁻) and lithium stoichiometries at 0% SOC (x₀, y₀). Panel (b) shows derived features include NP ratio and the lithium consumed during formation (Q_{SEI}). Each data point indicates an analyzed cell. Two batches of cells (black and red) showed significant differences in NPR and QSED highlighting the ability of our formation features to sense variability within and across different material batches.

FIG. 4 shows that our physics-based formation model [Ref. 12] simulates electrode potentials, solid electrolyte interphase (SEI) reduction currents for multiple SEI-forming components ethylene carbonate (EC) and vinylene carbonate (VC), and total cell thickness expansion attributed to SEI.

FIG. 5 shows our experimental results [Ref. 7]. Panel (a) shows cell manufacturing with two formation protocols for twenty cells and cycle life testing for degradation and variability. Panel (b) shows feasibility of using formation features, such as the low-SOC resistance for lifetime performance. Black: baseline, red: fast formation.

FIG. 6 shows example usage of XPS to quantify SEI elemental composition. An ALD-coated SEI is more oxygen-rich than natively-grown SEI [Ref. 15].

FIG. 7 shows an example of a smart formation feature specification to improve process yield. Panel (a) shows traditional statistical specification limits during electrode processing are not physically meaningful. LSL: lower specification limit, USL: upper specification limit. Panel (b) shows NPR extracted at the end-of-line. The NPR sets a physically-relevant specification related to lithium plating increasing process yield for both the baseline process and under process drift.

FIG. 8 shows usage of a smart formation feature specification to prevent equipment downtime and improve overall equipment effectiveness (OEE).

FIG. 9 is a schematic showing identifying electrode process parameter setpoints to emulate upstream process drifts.

FIG. 10 is a schematic showing correlation of formation features to upstream process parameters, and development of a controller strategy enabling upstream process control via formation features.

FIG. 11 is a schematic showing formation protocol optimization.

FIG. 12 shows modeling battery formation according to a non-limiting embodiment of the present disclosure. Panel 1 of FIG. 12 shows a simplified single particle model. Panel 2 of FIG. 12 shows SEI Growth Dynamics. Panel 3 of FIG. 12 shows an expansion model. Panel 4 of FIG. 12 shows an SEI growth boosting model. Panel 5 of FIG. 12 shows a multi species reactions model.

FIG. 13 shows smart formation according to a non-limiting embodiment of the present disclosure. FIG. 13 shows three example pillars of smart formation. Panel 1 of FIG. 13 shows that formation features enable scalable non-destructive extraction of electrochemically meaningful performance metrics at the end-of-line via formation [Ref. 2]. Panel 2 of FIG. 13 shows that physics-based formation models can set a foundation for interpreting formation features, developing new formation features, and enabling model-based control of formation protocols [Ref. 12]. Panel 3 of FIG. 13 shows that lifetime understanding enables the setting of formation feature specifications for example the resistance at low state of charge (Rios, 5% soc) informed by end of life performance [Ref. 7].

FIG. 14 shows model validation for non-limiting embodiments of the present disclosure. Panel A shows first cycle efficiency comparing a model and experimental data. Panel B shows first cycle vinylene carbonate (VC) reduction peak comparing models and experimental data. Panel C shows lithium stoichiometry at the end of formation verified by dV/dQ fitting.

FIG. 15 shows lifetime simulations for non-limiting embodiments of the present disclosure.

FIG. 16 shows a battery formation controller design for a non-limiting embodiment of the present disclosure.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. Skilled artisans will recognize the examples provided herein have many useful alternatives and fall within the scope of embodiments of the invention.

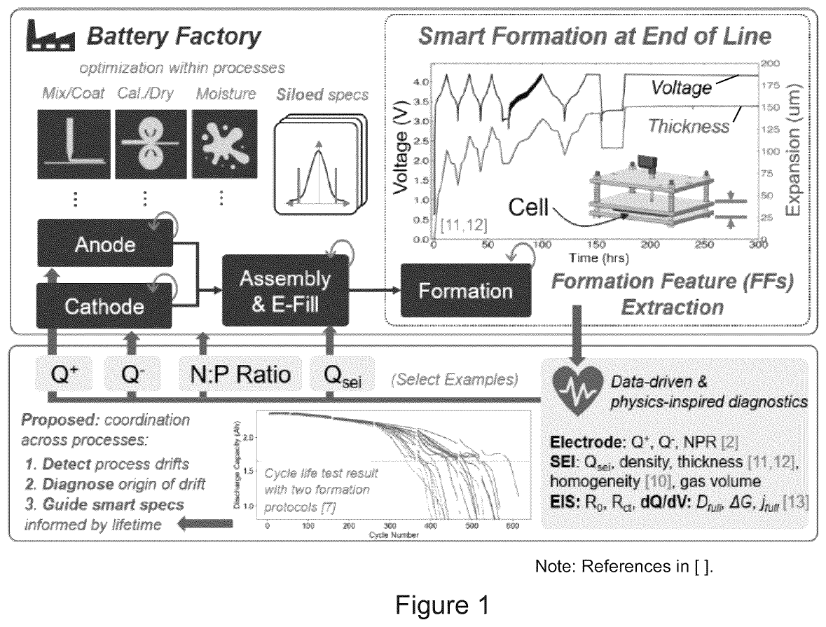

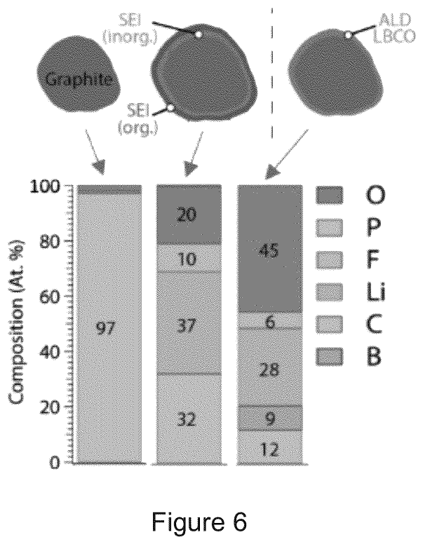

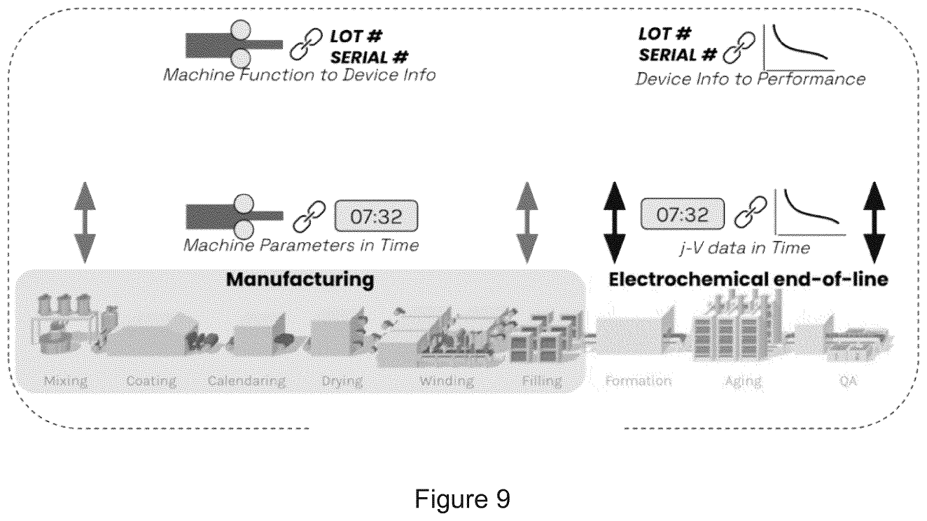

Turning now to FIGS. 1 and 9, steps in a battery manufacturing method of the present disclosure are shown. In a non-limiting example method for forming a cathode for the battery, the method comprises exposing anode material particles (such as graphite) to a lithium-containing precursor followed by an oxygen-containing precursor and thereafter exposing the anode material particles to a boron-containing precursor followed by the oxygen-containing precursor to form a coating, such as LBCO (Li₃BO₃—Li₂CO₃), on the anode material particles. The coating can be a nanoscale film that increases wettability of the liquid electrolyte on the anode material particles. Coated anode particles are shown in FIG. 6. A slurry comprising the coated anode material particles is prepared, and the slurry is cast on a surface to form a layer. The layer is calendered and then dried to remove moisture.

The method also comprises exposing cathode material particles (such as NMC) to a lithium-containing precursor followed by an oxygen-containing precursor and thereafter exposing the anode material particles to a boron-containing precursor followed by the oxygen-containing precursor to form a coating, such as LBCO (Li₃BO₃—Li₂CO₃), on the cathode material particles. The coating can be a nanoscale film that increases wettability of the liquid electrolyte on the cathode material particles. Coated cathode particles are similar to the coated anode particles shown in FIG. 6. A slurry comprising the coated cathode material particles is prepared, and the slurry is cast on a surface to form a layer. The layer is calendered and then dried to remove moisture.

The layer of the anode and the cathode as discussed in any of the preceding embodiments may be dried and calendered to have a thickness that ranges between 1 to 200 microns. In some embodiments, the thickness of the electrode is less than 175 microns, or less than 150 microns, or less than 125 microns, or less than 100 microns, or less than 75 microns, or less than 50 microns.

Anode materials could include carbonaceous materials (graphite, soft carbon, hard carbon) and composites thereof, composites of graphite and Si, lithium titanate (LTO), lithium metal, etc. Cathode material particles can be selected from the group consisting of lithium metal oxides wherein the metal is one or more of aluminum, cobalt, iron, manganese, nickel, vanadium, and lithium-containing phosphates having a general formula LiMPO₄ wherein M is one or more of cobalt, iron, manganese, and nickel. The cathode material particles can be selected from the group consisting of cathode material particles having a formula LiNiₐMn_{b}CO_{c}O₂, wherein a+b+c=1 and a:b:c=(NMC 111), a:b:c=4:3:3 (NMC 433), a:b:c=5:2:2 (NMC 522), a:b:c=5:3:2 (NMC 532), a:b:c=6:2:2 (NMC 622), or a:b:c=8:1:1 (NMC 811).

In the method, the anode layer and the cathode layer can be wound with a separator in between to create an unformed cell. An example separator material for the lithium battery can a permeable polymer such as a polyolefin. Example polyolefins include polyethylene, polypropylene, and combinations thereof. The separator may have a thickness in the range of 1 to 200 nanometers, or in the range of 40 to 1000 nanometers. The wound unformed cell is placed in a suitable container and the container is filled with a liquid electrolyte.

The electrolyte for the battery may be a liquid electrolyte. The liquid electrolyte of the battery may comprise a lithium compound in an organic solvent. The lithium compound may be selected from LiPF₆, LiBF₄, LiClO₄, lithium bis(fluorosulfonyl)imide (LiFSI), LiN(CF₃SO₂)₂(LiTFSI), and LiCF₃SO₃(LiTf). The organic solvent may be selected from carbonate based solvents, ether based solvents, ionic liquids, and mixtures thereof. The carbonate based solvent may be selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, and butylene carbonate; and the ether based solvent is selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, and 1,4-dioxane.

The unformed battery cell then undergoes a battery cell formation which is the process of initially charging and discharging the cell after it has been assembled. After the formation process, the battery goes through a period of aging, which involves repeated cycles at different rates and rest times. The purpose of aging is to stabilize the battery's electrochemical performance and make its voltage more accurate. Aging can be done at room temperature or at a higher temperature. The aged battery cells then proceed to quality assurance (QA) steps. As shown in FIG. 9, in the present invention mixing, coating, calendaring, drying, winding, and filling can be grouped as “manufacturing” steps, while formation, aging, and quality assurance can be grouped as “electrochemical end-of-line” steps.

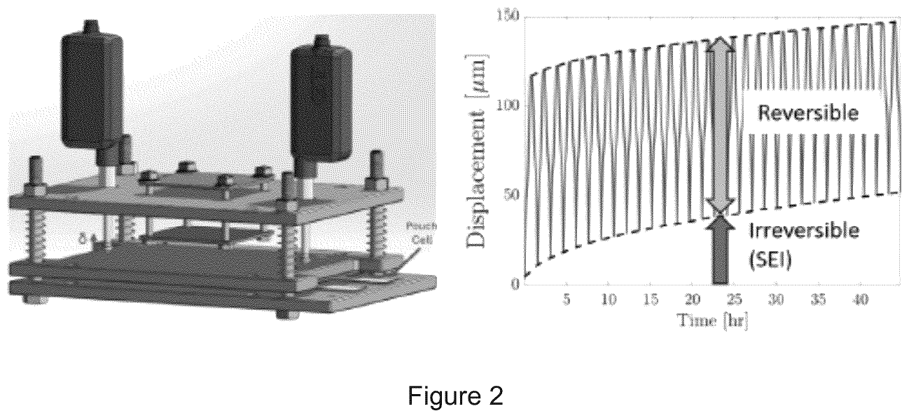

As shown in FIG. 1, formation feature extraction can occur during the formation process. A low-cost cell thickness measurement platform using inductive sensors [Ref. 11] (see FIG. 2) can be used to reduce measurement costs. With this platform, it has been demonstrated that SEI thickness is macroscopically measurable [Ref. 12].

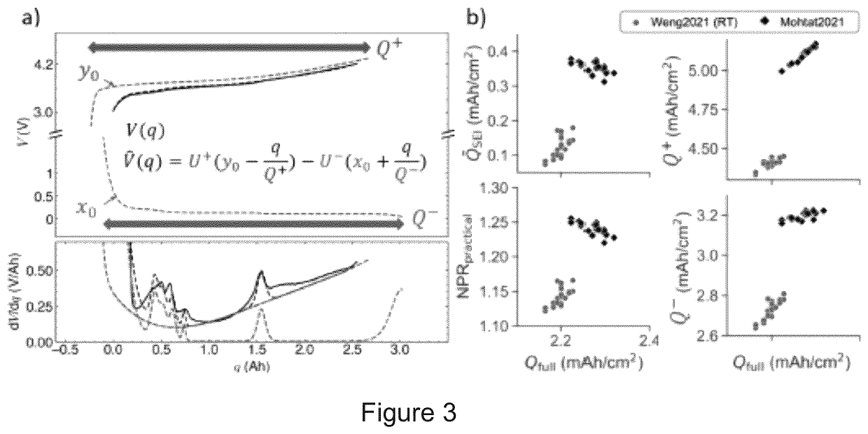

In the method of the invention, formation features can be used as electrochemical end-of-line diagnostic tools. Raw current, voltage and expansion data collected during formation need to be processed to derive electrochemically meaningful performance metrics (formation features). It is possible to use model-based methods to estimate the negative-to-positive ratio (NPR), quantity of lithium consumed to form the SEI (Qₛₑᵢ), cathode capacity (Q⁺), and anode capacity (Q⁻) for an NMC/graphite system and across two material batches (see FIG. 3, Ref [2]). These features give direct insight into the electrochemical properties at a component level and do so non-destructively. Formation data is scalable. Electrode and SEI heterogeneity can be quantified through an extended dV/dQ analysis method we recently developed involving quantifying dV/dQ peak broadening [Ref. 10]. Recent work also demonstrated the usage of dQ/dV to extract additional electrochemically relevant features, including Gibbs free energy, whole-cell lithium-ion diffusion coefficient, and exchange current density [Ref. 13].

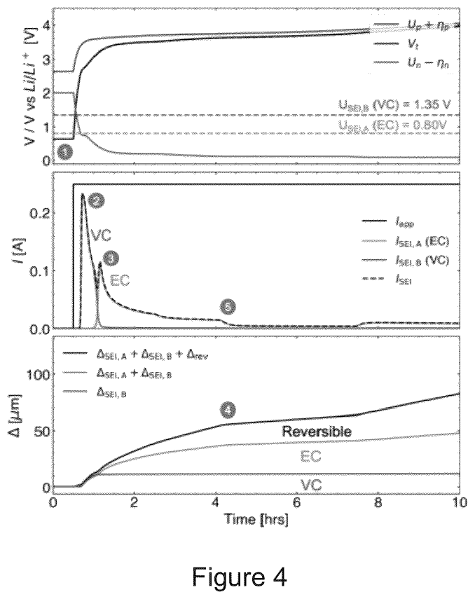

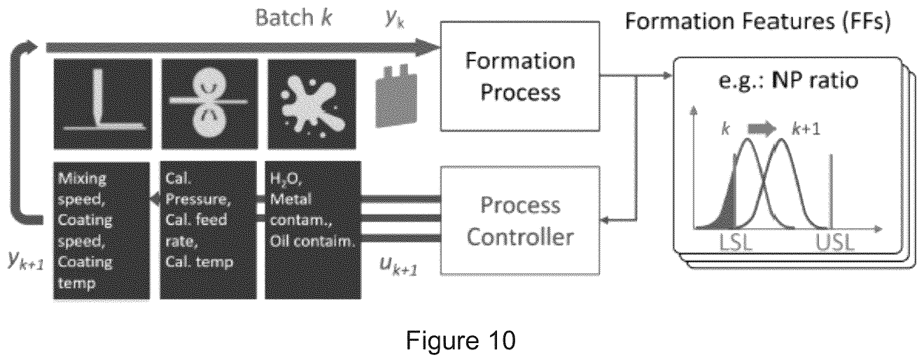

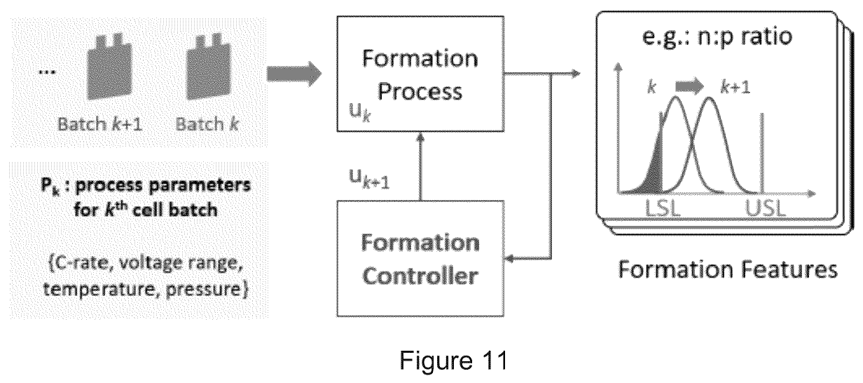

In the method of the invention, formation features can be used for upstream process control. A controller can use a physics-based process model of the battery formation process wherein the model leverages SEI modeling methods to develop real-time estimation of battery internal states during the formation cycling process (e.g., SEI reaction rates, anode potential, electrode expansion rates, cell thickness expansion, lithium consumed during formation) (see FIG. 4 and Ref. 12). Unlike other models of SEI (e.g., atomistic, Monte Carlo), the model predicts cell states in the context of a full cell. The model-based filtering can extract formation features under fast or specialized protocols. FIG. 10 is a schematic showing correlation of formation features to upstream process parameters, and development of a controller strategy enabling upstream process control via formation features. FIG. 11 is a schematic showing formation protocol optimization.

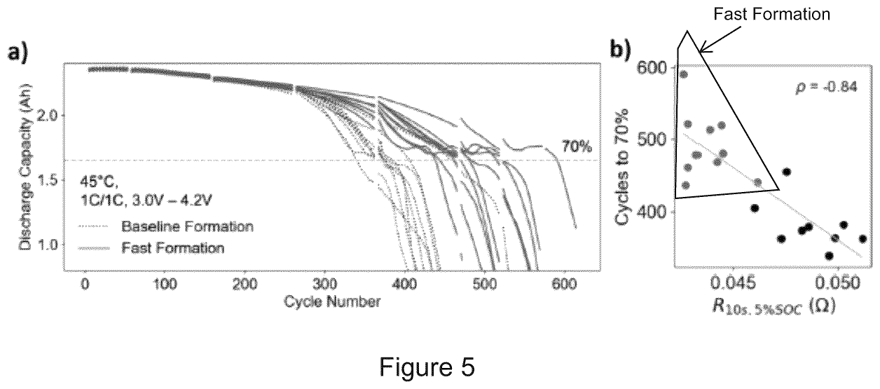

In the method of the invention, formation features can be used to predict end-of-life battery performance (see Ref [7]). For example, a resistance-based metric measured at low state of charge (SOC) is correlated to cycles until 70% capacity retention (see FIG. 5).

Formation features are ultimately proxies to true electrochemical properties. Given the importance of forming a stable solid electrolyte interphase (SEI) layer during formation, leveraging tools for quantifying SEI properties and correlating these properties to formation features is needed to build trust that formation features are providing electrochemically meaningful signals. Towards this goal, glovebox-integrated metrology equipment (XPS, AFM, FTIR, Optical imaging, GC/MS) is suited to this task. As an example, the elimination of ethylene carbonate (EC) decomposition during formation cycling by forming an “artificial SEI” with atomic layer deposition (ALD), which was characterized by operando video microscopy and dQ/dV analysis, and understood through post-mortem XPS, TEM, and teardown analysis [Ref. 15]. These skills and tools provide understanding the relationships between formation feature protocols and the associated changes in SEI composition, phase, and structure.

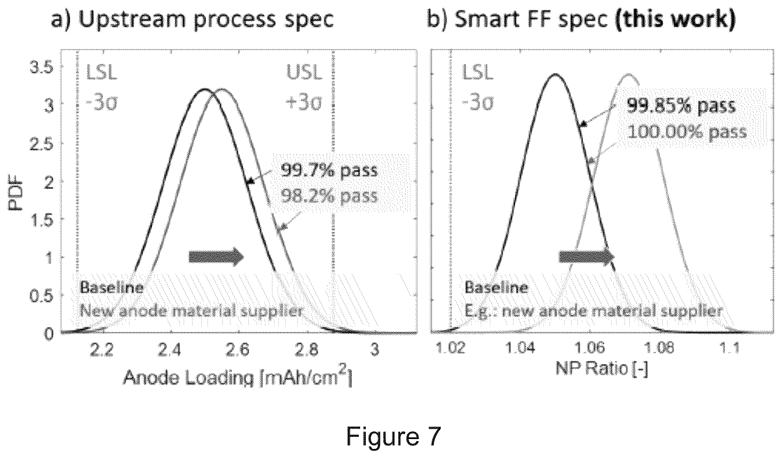

In the method of the invention, FIG. 7 shows how a smart formation feature specification such as the negative-to-positive ratio (NPR) can improve yield. NPR can be communicated with limited measurements [Ref. 22] and set a lower specification limit (LSL) to buffer against lithium plating [Ref. 2]. Unlike a purely statistical ±3σ specification, the NPR spec sets a single-sided limit since lithium plating is only a risk for low values of NPR; hence, the rejection rate can be halved, from 0.3% to 0.15%. FIG. 7 panel b further highlights the effect of an upstream process drift, e.g., due to introduction of a new anode supplier, which increases the mean anode loading. In this case, a mean-shift of +2% loading results in a six-fold increase in reject rate, from 0.3% to 1.8% (panel a). However, when the NPR metric is used instead (panel b), we see that increasing anode loading increases the NPR which actually protects against lithium plating and hence eliminates unneeded scrap.

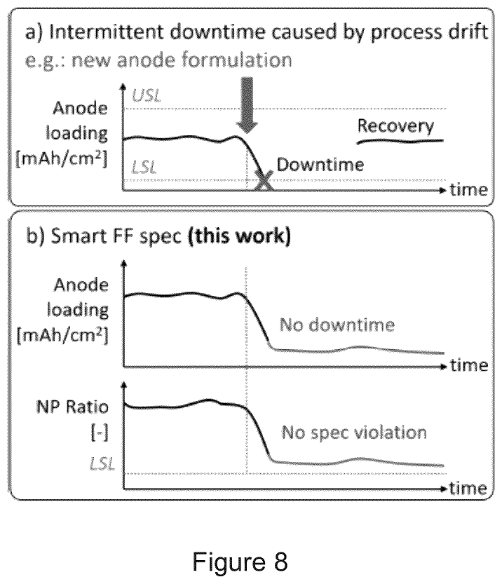

In the method of the invention, FIG. 8 shows how a smart formation feature spec can improve equipment uptime. In this example, a new anode material formulation causes the anode loading to decrease, e.g., due to a less viscous electrode slurry. The loading decrease would normally trigger a “spec-out-of-bounds” alarm (panel a), requiring equipment process recalibration, e.g., to adjust coating speed or mixing conditions, and causing down-time. A nominal estimate for equipment downtime is 12 hours which represents a 93% overall equipment effectiveness (OEE) assuming the equipment remains operational for a week, 24 hours a day. By comparison, a smart formation feature evaluates the effect of the anode loading drift using a physically-relevant metric, the NPR (panel b). In this example, the NPR LSL is not violated despite the anode loading decrease, and hence no equipment recalibration is needed.

The non-limiting examples above show how a single formation feature, the NPR, can be used to improve yield and OEE. Overall, exact numerical improvements will differ for each manufacturer and cell type. We also only highlighted two applications from extracting a single formation feature, the NPR at the end of line. By enabling additional (12+) formation features, closed-loop upstream process control, and lifetime-informed end-of-line specs, additional benefits to manufacturing cost, efficiency, and circularity, can be realized.

In one aspect, the present invention provides a method for manufacturing an electrochemical cell including an anode, an electrolyte, and a cathode including cations that move from the cathode to the anode during a charging phase, The method comprises: (a) obtaining a measurement of an electrochemical feature at a selected time in a formation charging phase for creating the electrochemical cell from a cell structure, wherein the electrochemical feature is other than capacity, resistance, and voltage decay; and (b) maintaining or adjusting, based on the measurement of the electrochemical feature, at least one process parameter of a manufacturing process selected from: a production process for an anode of a later-produced electrochemical cell, a production process for a cathode of the later-produced electrochemical cell, an assembly process for a cell structure of the later-produced electrochemical cell, a filling process for an electrolyte of the later-produced electrochemical cell, and a formation charging process of the later-produced electrochemical cell.

In one embodiment, step (b) comprises maintaining or adjusting, based on the measurement of the electrochemical feature, at least one process parameter of a production process for an anode of the later-produced electrochemical cell. In one embodiment, step (b) comprises maintaining or adjusting, based on the measurement of the electrochemical feature, at least one process parameter of a production process for a cathode of the later-produced electrochemical cell. In one embodiment, step (b) comprises maintaining or adjusting, based on the measurement of the electrochemical feature, at least one process parameter of an assembly process for a cell structure of the later-produced electrochemical cell. In one embodiment, step (b) comprises maintaining or adjusting, based on the measurement of the electrochemical feature, at least one process parameter of a filling process for an electrolyte of the later-produced electrochemical cell. In one embodiment, step (b) comprises maintaining or adjusting, based on the measurement of the electrochemical feature, at least one process parameter of a formation charging process of the later-produced electrochemical cell. In one embodiment, step (b) comprises maintaining or adjusting the at least one process parameter based on a physics-based model that uses the measurement of the electrochemical feature.

In one embodiment, the physics-based model is a solid electrolyte interphase growth model. In one embodiment, the physics-based model comprises a trained machine learning model that is trained on a signal based on the electrochemical feature.

In one embodiment, step (a) further comprises repeating step (a) a plurality of times to obtain a plurality of measurements of the electrochemical feature; and step (b) further comprises maintaining or adjusting the at least one process parameter when the plurality of measurements of the electrochemical feature indicate process drift of a process parameter of the method for manufacturing an electrochemical cell. In one embodiment, step (b) further comprises determining origin of the process drift. In one embodiment, step (b) comprises maintaining the at least one process parameter.

In one embodiment, the electrochemical feature is at least one of: positive capacity ratio (NPR), solid electrolyte interphase (SEI) density, SEI thickness, cations consumed during formation (Q_{SEI}), anode loading (Q⁻), cathode loading (Q⁺), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (R_{ct}) from Electrochemical Impedance Spectroscopy (EIS), short resistance, Gibbs free energy, whole-cell lithium-ion diffusion coefficient, exchange current density, gas volume, and water content. In one embodiment, the electrochemical feature is negative to positive capacity ratio (NPR). In one embodiment, the electrochemical feature is cations consumed during formation (Q_{SEI}). In one embodiment, the electrochemical feature is anode loading (Q⁻). In one embodiment, the electrochemical feature is cathode loading (Q⁺). In one embodiment, the electrochemical feature is solid electrolyte interphase (SEI) density. In one embodiment, the selected time in the formation charging phase is after completion of the formation charging phase.

In one embodiment, the anode comprises an anode material selected from graphite, lithium titanium oxide, hard carbon, tin/cobalt alloys, silicon/carbon, or lithium metal, the electrolyte comprises a liquid electrolyte including a lithium compound in an organic solvent, and the cathode comprises a cathode active material selected from (i) lithium metal oxides wherein the metal is one or more aluminum, cobalt, iron, manganese, nickel and vanadium, (ii) lithium-containing phosphates having a general formula LiMPO₄ wherein M is one or more of cobalt, iron, manganese, and nickel, and (iii) materials having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). In one embodiment, the anode comprises graphite, the lithium compound is selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf), the organic solvent is selected from carbonate based solvents, ether based solvents, ionic liquids, and mixtures thereof, the carbonate based solvent is selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, and butylene carbonate, and mixtures thereof, and the ether based solvent is selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, and 1,4-dioxane, and mixtures thereof.

In one embodiment, the cations are lithium cations. In one embodiment, the anode comprises an anode material selected from sodium ions and sodium metal. In one embodiment, the anode comprises silicon.

In one embodiment, the measurement of the electrochemical feature comprises measuring expansion of the electrochemical cell using an expansion fixture instrumented with an inductive proximity sensor. In one embodiment, the measurement of the electrochemical feature comprises measuring expansion of the electrochemical cell using an expansion fixture instrumented with a linear displacement sensor. In one embodiment, the measurement of the electrochemical feature comprises measuring expansion of the electrochemical cell using an expansion fixture instrumented with a load cell.

In another aspect, the present invention provides a method for manufacturing an electrochemical cell including an anode, an electrolyte, and a cathode including cations that move from the cathode to the anode during a charging phase. The method comprises: (a) obtaining a measurement of an electrochemical feature at a selected time in a formation charging phase for creating the electrochemical cell from a cell structure, wherein the electrochemical feature is other than capacity, resistance, and voltage decay; and (b) detecting or ruling out a manufacturing defect, based on the measurement of the electrochemical feature. In one embodiment, the manufacturing defect is metal contamination. In one embodiment, the manufacturing defect is moisture. In one embodiment, the manufacturing defect is an internal short.

In one embodiment, the electrochemical feature is at least one of: positive capacity ratio (NPR), solid electrolyte interphase (SEI) density, SEI thickness, cations consumed during formation (Q_{SEI}), anode loading (Q⁻), cathode loading (Q⁺), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (Ret) from Electrochemical Impedance Spectroscopy (EIS), short resistance, Gibbs free energy, whole-cell lithium-ion diffusion coefficient, exchange current density, gas volume, and water content. In one embodiment, the electrochemical feature is negative to positive capacity ratio (NPR). In one embodiment, the electrochemical feature is cations consumed during formation (Q_{SEI}). In one embodiment, the electrochemical feature is anode loading (Q⁻). In one embodiment, the electrochemical feature is cathode loading (Q⁺). In one embodiment, the electrochemical feature is solid electrolyte interphase (SEI) density. In one embodiment, the selected time in the formation charging phase is after completion of the formation charging phase.

In one embodiment, the anode comprises an anode material selected from graphite, lithium titanium oxide, hard carbon, tin/cobalt alloys, silicon/carbon, or lithium metal, the electrolyte comprises a liquid electrolyte including a lithium compound in an organic solvent, and the cathode comprises a cathode active material selected from (i) lithium metal oxides wherein the metal is one or more aluminum, cobalt, iron, manganese, nickel and vanadium, (ii) lithium-containing phosphates having a general formula LiMPO₄ wherein M is one or more of cobalt, iron, manganese, and nickel, and (iii) materials having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). In one embodiment, the anode comprises graphite, the lithium compound is selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf), the organic solvent is selected from carbonate based solvents, ether based solvents, ionic liquids, and mixtures thereof, the carbonate based solvent is selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, and butylene carbonate, and mixtures thereof, and the ether based solvent is selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, and 1,4-dioxane, and mixtures thereof.

In one embodiment, the cations are lithium cations. In one embodiment, the anode comprises an anode material selected from sodium ions and sodium metal. In one embodiment, the anode comprises silicon.

In yet another aspect, the present invention provides a method for predicting end of life of an electrochemical cell including an anode, an electrolyte, and a cathode including cations that move from the cathode to the anode during a charging phase. The method comprises: (a) obtaining a measurement of an electrochemical feature at a selected time in a formation charging phase for creating the electrochemical cell from a cell structure, wherein the electrochemical feature is other than capacity, resistance, and voltage decay; and (b) determining end of life of the electrochemical cell based on the measurement of the electrochemical feature. In one embodiment, the electrochemical feature is at least one of: positive capacity ratio (NPR), solid electrolyte interphase (SEI) density, SEI thickness, cations consumed during formation (Q_{SEI}), anode loading (Q⁻), cathode loading (Q⁺), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (Rot) from Electrochemical Impedance Spectroscopy (EIS), short resistance, Gibbs free energy, whole-cell lithium-ion diffusion coefficient, exchange current density, gas volume, and water content. In one embodiment, the electrochemical feature is negative to positive capacity ratio (NPR). In one embodiment, the electrochemical feature is cations consumed during formation (Q_{SEI}). In one embodiment, the electrochemical feature is anode loading (Q⁻).

In one embodiment, the electrochemical feature is cathode loading (Q⁺). In one embodiment, the electrochemical feature is solid electrolyte interphase (SEI) density. In one embodiment, the selected time in the formation charging phase is after completion of the formation charging phase.

In one embodiment, the anode comprises an anode material selected from graphite, lithium titanium oxide, hard carbon, tin/cobalt alloys, silicon/carbon, or lithium metal, the electrolyte comprises a liquid electrolyte including a lithium compound in an organic solvent, and the cathode comprises a cathode active material selected from (i) lithium metal oxides wherein the metal is one or more aluminum, cobalt, iron, manganese, nickel and vanadium, (ii) lithium-containing phosphates having a general formula LiMPO₄ wherein M is one or more of cobalt, iron, manganese, and nickel, and (iii) materials having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). In one embodiment, the anode comprises graphite, the lithium compound is selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf), the organic solvent is selected from carbonate based solvents, ether based solvents, ionic liquids, and mixtures thereof, the carbonate based solvent is selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, and butylene carbonate, and mixtures thereof, and the ether based solvent is selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, and 1,4-dioxane, and mixtures thereof.

In one embodiment, the cations are lithium cations. In one embodiment, the anode comprises an anode material selected from sodium ions and sodium metal. In one embodiment, the anode comprises silicon.

In still another aspect, the present invention provides a system for manufacturing an electrochemical cell including an anode, an electrolyte, and a cathode including cations that move from the cathode to the anode during a charging phase. The system comprises: a sensor that generates signals from measurement of an electrochemical feature at a selected time in a formation charging phase for creating the electrochemical cell from a cell structure, wherein the electrochemical feature is other than capacity, resistance, and voltage decay; and a controller in electrical communication with the sensor, the controller executing a program stored in the controller to: (i) receive the signals from measurement of the electrochemical feature, and (ii) maintain or adjust, based on the signals, at least one process parameter of a manufacturing process selected from: a production process for an anode of a later-produced electrochemical cell, a production process for a cathode of the later-produced electrochemical cell, an assembly process for a cell structure of the later-produced electrochemical cell, a filling process for an electrolyte of the later-produced electrochemical cell, and a formation charging process of the later-produced electrochemical cell. In one embodiment, the program includes a physics-based model that uses as an input the signals. In one embodiment, the physics-based model is a solid electrolyte interphase growth model. In one embodiment, the physics-based model comprises a trained machine learning model that is trained on the signals.

In one embodiment, the electrochemical feature is at least one of: positive capacity ratio (NPR), solid electrolyte interphase (SEI) density, SEI thickness, cations consumed during formation (Q_{SEI}), anode loading (Q⁻), cathode loading (Q⁺), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (Rot) from Electrochemical Impedance Spectroscopy (EIS), short resistance, Gibbs free energy, whole-cell lithium-ion diffusion coefficient, exchange current density, gas volume, and water content.

In one embodiment, the sensor generates the signals by sensing expansion of the electrochemical cell using an expansion fixture instrumented with an inductive proximity sensor. In one embodiment, the sensor generates the signals by sensing expansion of the electrochemical cell using an expansion fixture instrumented with a linear displacement sensor. In one embodiment, the sensor generates the signals by sensing expansion of the electrochemical cell using an expansion fixture instrumented with a load cell.

In yet another aspect, the present invention provides a system for manufacturing an electrochemical cell including an anode, an electrolyte, and a cathode including cations that move from the cathode to the anode during a charging phase. The system comprises: a sensor that generates signals from measurement of an electrochemical feature at a selected time in a formation charging phase for creating the electrochemical cell from a cell structure, wherein the electrochemical feature is other than capacity, resistance, and voltage decay; and a controller in electrical communication with the sensor, the controller executing a program stored in the controller to: (i) obtain a measurement of an electrochemical feature at a selected time in a formation charging phase for creating the electrochemical cell from a cell structure, wherein the electrochemical feature is other than capacity, resistance, and voltage decay; and (ii) detect or rule out a manufacturing defect, based on the signals. In one embodiment, the program includes a physics-based model that uses as an input the signals. In one embodiment, the physics-based model is a solid electrolyte interphase growth model. In one embodiment, the physics-based model comprises a trained machine learning model that is trained on the signals.

In one embodiment, the electrochemical feature is at least one of: positive capacity ratio (NPR), solid electrolyte interphase (SEI) density, SEI thickness, cations consumed during formation (Q_{SEI}), anode loading (Q⁻), cathode loading (Q⁺), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (Ret) from Electrochemical Impedance Spectroscopy (EIS), short resistance, Gibbs free energy, whole-cell lithium-ion diffusion coefficient, exchange current density, gas volume, and water content.

In one embodiment, the sensor generates the signals by sensing expansion of the electrochemical cell using an expansion fixture instrumented with an inductive proximity sensor. In one embodiment, the sensor generates the signals by sensing expansion of the electrochemical cell using an expansion fixture instrumented with a linear displacement sensor. In one embodiment, the sensor generates the signals by sensing expansion of the electrochemical cell using an expansion fixture instrumented with a load cell.

### EXAMPLES

The Examples have been presented in order to further illustrate the invention and is not intended to limit the invention in any way. The statements provided in the Examples are presented without being bound by theory.

### Example 1

### Overview

Example 1 discloses a smart battery formation platform enabling coordinated manufacturing process control across multiple factory processes, from electrode manufacturing through to formation. A core innovation is the development of systems and methods for extracting electrochemical features from the formation process itself (i.e., formation features or FFs) at the end of the line (see FIG. 1). By expanding the repertoire of electrochemically relevant diagnostic features beyond cell capacity and resistance, the formation features will enable intelligent control of upstream process parameters (e.g., in electrode production) to improve manufacturing yield under the presence of material variability (e.g., due to supply chain volatility). The formation features will also help speed up the formation cycling protocol by guiding the design of minimum-time formation protocols subject to formation feature constraints (e.g., N:P ratio), decreasing manufacturing Operating Expenditure (OpEx) and Capital Expenditure (CapEx) costs. Finally, the formation features will help to set end-of-line cell specification setpoints/limits that are tied to battery lifetime, improving battery circularity.

### Background

The battery formation process is one of the most closely guarded trade secrets in battery manufacturing [Ref. 1]. It also accounts for up to 32% of total manufacturing costs, 27% of energy consumed, and is the slowest process in the factory [Ref. 9]. The lack of transparency in formation process know-how hinders the ability of new market entrants to set up battery factories quickly and operate at peak efficiency. Meanwhile, existing factories are also not taking full advantage of voltage-based measurements they already collect at the end of the line during formation. These measurements will bridge end-of-line features to downstream cell lifetime and durability as well as upstream manufacturing process deviations. However, they are not being fully leveraged, partly owing to difficulties in data interpretation [Ref. 2]. Speeding up formation [Ref. 3] reduces the observability of formation features which is a challenge we will directly address using model-based filtering. In the absence of sound estimation design principles and complexity in in-situ measurements [Ref. 4], manufacturers use conservative formation protocols that may be unnecessarily slow and energy-intensive. Once volume production begins, manufacturers are also less willing to change their legacy processes, given the lack of clarity on the long-term impact of updating formation protocols.

Formation features (FFs) do not necessarily replace the need for more advanced end-of-line metrology methods in the factory, including X-ray and ultrasonic imaging, which may be necessary for catching non-electrochemical related cell defects. Rather, our work complements the need for an expanded repertoire of root-cause methods necessary to ensure battery quality at scale [Ref. 5]. To quote an author, Dan Heath: “Getting short-term measures right is frustratingly complex. And it's critical. In fact, the only thing worse than contending with short-term measures is not having them at all” [Ref. 6]. Currently, battery factories have very few short-term measures of battery performance at the end of the line: capacity, resistance, and voltage decay. The present disclosure aims to drastically increase the number of these short-term performance measures with the development of formation features.

The project of Example 1 will develop and deploy the smart battery formation platform at the University of Michigan (UM) Battery Lab, an IP-neutral 0.5 MWh pouch cell pilot line accessible to our academic and industrial partners. We have teamed up to enable the hardware/software interface for collecting and processing data generated from electrode manufacturing to formation. Critical to this project is the development of reliable algorithms for formation feature extraction (UM), data analytics, cell teardown and formation feature validation (UM), and process control (UM). It has been shown that battery formation data can be used to predict battery lifetime for the first time [Ref. 7].

### Project

The project of this Example 1 aims to resolve core knowledge gaps preventing the development of smart battery formation platforms today:
What sensing platform is needed to extract FFs reliably and at scale?
What measurement conditions and algorithms can enable reproducible FF extraction?
Which upstream process parameter deviations can be detected using FFs?
Which FFs are related to solid electrolyte interphase (SEI) quality?
What are the trade-offs between formation speed and the quality of the FFs?
Which FFs are indicators of lifetime? Do these indicators change with the use case?

By addressing these challenges, we will demonstrate the usage of formation features (FF) as part of an integrated manufacturing data collection and control system. By the end of the project of Example 1, we aim to demonstrate at least three capabilities: (1) closed-loop control of upstream process parameters subject to formation feature constraints, (2) development of minimum-time formation protocols while maintaining formation feature target specs, and (3) setting smart formation feature specification limits informed by battery lifetime understanding.

### Impact

Battery manufacturing CapEx is currently around 2× in the U.S. compared to Asian cell producers [Ref. 8]. Given the high cost and energy burden of the battery manufacturing [Ref. 7], drastic process technology improvements are needed. By online processing of electric data during formation, we propose to develop smart end-of-line cell performance and manufacturing parameter specifications that can improve yield, equipment effectiveness, and cell costs. The formation features will improve the manufacturer's ability to pinpoint which parameter deviation in the manufacturing process caused shifts in electrochemical performance. Our group has the expertise [Ref. 2], publicly available data [Ref. 3], fast models [Ref. 5], and protected methodology [Ref. 4], along with tools [Ref. 2] demonstrated in Technology Readiness Level (TRL) 3-4 that use electrical data already collected from standard formation cycling equipment, thus bearing no additional capital costs. This Example 1 discloses an opportunity will enable our interdisciplinary team of experts across the battery R&D, data analytics, manufacturing, and industrial automation communities from academia, national labs, and industry to develop a TRL6 technology platform for increased capacity utilization, reduction of scrap, and manage upstream material variability.

### Technical Description, Innovation, and Impact Relevance and Outcomes

This disclosure addresses Battery Smart Manufacturing Platforms. We seek to transform the formation process from a burdensome but necessary manufacturing step to a centerpiece for integrated manufacturing process control. Given the existing CapEx challenges with starting new factories in the U.S., process technology development for the most expensive and energy-intensive step in manufacturing (formation) can help level the playing field. The formation features (FFs) we develop in this work can enable three new process technology capabilities with compounding benefits to manufacturing efficiency, costs, and circularity: (1) integrated control of upstream manufacturing processes, (2) fast formation protocol design, and (3) smart formation feature specifications informed by lifetime. These process technologies can be demonstrated. A pilot scale manufacturing line can serve as a testbed and resource for the continued domestic development of smart battery manufacturing technologies.

### Techniques

Sensing Platform. Formation features based on electrical signals alone (e.g., voltage, current) may be insufficient to obtain a rich understanding of solid electrolyte interphase (SEI) quality. However, adding more sensing capabilities increases CapEx which is already high. A low-cost cell thickness measurement platform using inductive sensors has been developed [Ref. 11] (see FIG. 2). This fixture platform reduced measurement costs from $2000 to $20 per channel. With this platform, it has been demonstrated that SEI thickness is macroscopically measurable [Ref. 12].

Formation Features as End-Of-Line Diagnostic Tools. Raw current, voltage and expansion data collected during formation need to be processed to derive electrochemically meaningful performance metrics (formation features). Our group has shown it is possible to use model-based methods to estimate the negative-to-positive ratio (NPR), quantity of lithium consumed to form the SEI (Qₛₑᵢ), cathode capacity (Q⁺), and anode capacity (Q⁻) for an NMC/Graphite system and across two material batches (see FIG. 3, Ref [2]). These features give direct insight into the electrochemical properties at a component level and do so non-destructively. Formation data is scalable. Electrode and SEI heterogeneity will be quantified through an extended dV/dQ analysis method we recently developed involving quantifying dV/dQ peak broadening [Ref. 10]. Recent work also demonstrated the usage of dQ/dV to extract additional electrochemically relevant features, including Gibbs free energy, whole-cell lithium-ion diffusion coefficient, and exchange current density [Ref. 13]. This project of Example 1 expands upon prior work by developing formation features for chemistries beyond NMC/Graphite, and establishing the relationship between these formation features and SEI material properties. Finally, we will develop a methodology to optimize the testing protocols and measurement parameters needed to reproducibly extract formation features.

Model-Based Design of Fast Formation Protocols. Several project tasks involve demonstrating formation features for upstream process control. These controllers can use a physics-based process model of the battery formation process recently developed [Ref. 12]. The model leverages SEI modeling methods to develop real-time estimation of battery internal states during the formation cycling process (e.g., SEI reaction rates, anode potential, electrode expansion rates, cell thickness expansion, lithium consumed during formation) (see FIG. 4). Unlike other models of SEI (e.g., atomistic, Monte Carlo), our model predicts cell states in the context of a full cell. We will demonstrate that model-based filtering will extract formation features under fast or specialized protocols.

Battery Lifetime Prediction Using Formation Features. The connection between formation features and end-of-life battery performance was verified in Ref [7]. This work established the potential to improve battery lifetime prediction models using formation features. We specifically found that a resistance-based metric measured at low state of charge (SOC) is correlated to cycles until 70% capacity retention (see FIG. 5). This project of Example 1 will expand the correlation between formation features and lifetime performance to identify more early warning signals that can indicate future warranty costs. Attributing lifetime implications to formation features is a key step toward improving battery circularity.

SEI Materials Characterization. Formation features are ultimately proxies to true electrochemical properties. Given the importance of forming a stable solid electrolyte interphase (SEI) layer during formation, leveraging tools for quantifying SEI properties and correlating these properties to formation features is needed to build trust that formation features are providing electrochemically meaningful signals. Towards this goal, a University of Michigan lab is equipped with a unique suite of glovebox-integrated metrology equipment (XPS, AFM, FTIR, Optical imaging, GC/MS), specifically suited to this task. As an example, University of Michigan has demonstrated the elimination of ethylene carbonate (EC) decomposition during formation cycling by forming an “artificial SEI” with Atomic Layer Deposition (ALD), which was characterized by operando video microscopy and dQ/dV analysis, and understood through post-mortem XPS, TEM, and teardown analysis [Ref. 15]. These skills and tools will be critical to understanding the relationships between formation feature protocols and the associated changes in SEI composition, phase, and structure in this project.

### Innovation and Impacts

The project of the Example 1 will demonstrate how the formation features have compounding benefits to manufacturing cost, efficiency, and circularity. The first example (see FIG. 7) shows how a smart formation feature specification such as the negative-to-positive ratio (NPR) can improve yield. Our team has algorithms for computing NPR with limited measurements [Ref. 22] and set a lower specification limit (LSL) to buffer against lithium plating [Ref. 2]. Unlike a purely statistical ±3σ specification, the NPR spec sets a single-sided limit since lithium plating is only a risk for low values of NPR; hence, the rejection rate can be halved, from 0.3% to 0.15%. FIG. 7 panel b further highlights the effect of an upstream process drift, e.g., due to introduction of a new anode supplier, which increases the mean anode loading. In this case, a mean-shift of +2% loading results in a six-fold increase in reject rate, from 0.3% to 1.8% (panel a). However, when the NPR metric is used instead (panel b), we see that increasing anode loading increases the NPR which actually protects against lithium plating and hence eliminates unneeded scrap.

The second example (see FIG. 8) shows how a smart formation feature spec can improve equipment uptime. In this example, a new anode material formulation causes the anode loading to decrease, e.g., due to a less viscous electrode slurry. The loading decrease would normally trigger a “spec-out-of-bounds” alarm (panel a), requiring equipment process recalibration, e.g., to adjust coating speed or mixing conditions, and causing down-time. A nominal estimate for equipment downtime is 12 hours which represents a 93% overall equipment effectiveness (OEE) assuming the equipment remains operational for a week, 24 hours a day. By comparison, a smart formation feature evaluates the effect of the anode loading drift using a physically-relevant metric, the NPR (panel b). In this example, the NPR LSL is not violated despite the anode loading decrease, and hence no equipment recalibration is needed.

The examples above show how a single formation feature, the NPR, can be used to improve yield and OEE. Overall, exact numerical improvements will differ for each manufacturer and cell type. We also only highlighted two applications from extracting a single formation feature, the NPR at the end of line. By enabling additional (12+) formation features, closed-loop upstream process control, and lifetime-informed end-of-line specs, additional benefits to manufacturing cost, efficiency, and circularity, can be realized. A summary of capabilities and metrics are given in Table 1.

TABLE 1
List of metrics/capabilities used to benchmark the project. Asterisks (*) indicate stretch goals.

| Metric/Capability | Industry Baseline | Final Target (end; TRL6) | State of the Art (Literature) |
|---|---|---|---|
| Reject rate (yield) | (depends on manufacturer) | 0.15% (baseline) | 0.3% (baseline) |
| | | 0.00% (with process drift) | 1.8% (with process drift) |
| | | Based on ex. from FIG. 7 | Based on ex. from FIG. 7 |
| Electrode overall equipment | (depends on manufacturer) | 100% (process drift) | 93% (process drift) |
| effectiveness (OEE) | | Based on ex. from FIG. 8 | Based on ex. from FIG. 8 |
| Number of physically-relevant | 3 FFs (capacity, resistance, | 12+ FFs: Q⁻, Q⁺, NPR, Qₛₑᵢ, x₀, y₀ | 6 FFs under 1 formation |
| formation features (FFs) at | OCV decay) | [Ref. 2], cell thickness | condition and full voltage |
| the end-of-line | | [Ref. 11], homogeneity metrics | range (Ref [2]) |
| | | [Ref. 10], dQ/dV metrics [Ref. 13], | |
| | | R₀, R_{ct} from EIS, data-driven features, | |
| | | short resistance*, water content* | |
| Formation data availability | (not publicly available) | 150+ cells; 3 chemistries; 8+ | 45+ cells, as part of Refs [2, 7]; |
| | | manufacturing process variants; | 1 chemistry (NMC/Gr) 2 material |
| | | 10+ formation conditions | batches; 1 manufacturing process |
| | | (temperature, C-rates, voltage | variant; 2 formation conditions |
| | | ranges, pressures) | |
| New capability: FFs detect | Manual | Diagnose drifts in 4 processes | Differences between two material |
| drifts and diagnose origin | | (electrode mix, coat, calendar, | batches shown at TRL3 level |
| | | moisture) via end of line FFs. | Ref [2] |
| New capability: factory | Siloed; each process sets | Coordinated; FFs specifications | Siloed; Electrode structure- |
| specification limit setting | its own specification | at the end-of-line inform upstream | performance via computational |
| strategy (yield & scrap rate) | limits | specifications; FF specifications | models; no end-of-line feedback |
| | | are lifetime-informed | [Ref. 16] |
| FF generalizability to | (not publicly available) | 4 chemistries (NMC/GR, NMC/ | chemistry (NMC/Gr), |
| different process | | Gr + Si, LFP/Gr, LMFP/Gr), | material batches, |
| conditions and materials | | 8+ manuf. process variants, | 1 formation condition (base) |
| | | 10+ formation conditions | (Ref [2]) |
| Formation time | 60 hours (C/10 x3), Univ. | Minimum-time protocol based on | 14 hours (Ref [3,7]); w 40+ pouch |
| | of Michigan Battery-Lab | smart formation feature | cells (1.5 Ah) |
| | | specifications | |
| New capability: adaptive | Static; no detection/ | Adaptive; detects/adapts to upstream | Static; does not adapt to upstream |
| formation protocol | adaptation to upstream | process disturbances from supply | process disturbances [Ref. 3]; |
| | disturbances; conservative | chain; adjust formation temperature, | conservative based on lowest |
| | & heuristic | C-rate, voltage window, pressure | common denominator |

The present disclosure provide systems and methods that enable reliable extraction of electrochemical features (a.k.a. formation features, or FFs) during the formation process at the end of the manufacturing line. We will demonstrate the usage of formation features to: (1) enable closed-loop control of upstream process parameters subject to formation feature constraints, (2) develop minimum-time formation protocols while maintaining formation feature spec limits, and (3) set formation feature spec limits based on battery lifetime understanding.

### Technical Scope Summary

The project of Example 1 is organized into six tasks. Task 1 will demonstrate the use of formation features to update upstream process parameters. Task 2 will establish methods for reproducible extraction of formation features for multiple chemistries and relate formation features to solid electrolyte interphase (SEI) quality. Task 3 will demonstrate the use of formation features to design minimum-time formation protocols and quantify trade-offs between formation speed and formation feature signal quality. Task 4 will develop formation feature specification limits informed by lifetime data.

### Task Description Summary

Task 1: Control of Upstream Process Parameters via Formation Features: Formation features (FFs) are sensitive to changes in upstream process variability and can provide closed-loop feedback to upstream processes; allowing demonstration of real-time data acquisition capability in the pilot lab to enable coordinated control of multiple manufacturing processes via formation features.
Task 1.1: Identify electrode process parameter setpoints to emulate upstream process drifts. To demonstrate the use of formation features to detect upstream process variability, we can build cells with different process variability and measure their formation features at the end of line. This preliminary task identifies relevant electrode machine settings to achieve the necessary variance in process parameters. We mostly focus on anode electrode parameter variation which is expected to have a larger impact on the SEI formation process. We could adopt a partial factorial design-of-experiments approach (see Table 2) to study sensitivities starting with a small sample space. Bayesian optimization approaches will discover electrode process parameters that most affect formation features including anode loading, anode density, cathode loading, anode dispersion (viscosity), moisture content, and metal contamination.

TABLE 2
Cell Build Plan with Two Main Axes: Process Variations (rows) and Formation Protocols (columns)

| | | | | | | | Temperature | | | Electrical Protocol | | | | Pressure | | |
|---|---|---|---|---|---|---|---|---|---|---|---|---|---|---|---|---|
| T1.•Effect of Varying Manufacturing Process Parameters | | | | | | | Base | Base | Base | Fast1 | Fast2 | Fast3 | Fast4 | Base | Base | |
| T3. Effect of Formation Protocols | | | | | | | 40 C. | 25 C. | 55 C. | 40 C. | 40 C. | 40 C. | 40 C. | 40 C. | 40 C. | |
| Total Cells: 154 | | | | | | | 5 PSI | 5 PSI | 5 PSI | 5 PSI | 5 PSI | 5 PSI | 5 PSI | 0 PSI | 10 PSI | |
| Mixing | Mix1 | Moist1 | Cal1 | Elyte1 | Coat1 | NMC/Gr | 10 | 6 | 6 | 6 | 6 | 6 | 6 | 6 | 6 | 58 |
| | Mix2 | Moist1 | Cal1 | Elyte1 | Coat1 | NMC/Gr | 6 | | | | | | | | | 6 |
| | Mix3 | Moist1 | Cal1 | Elyte1 | Coat1 | NMC/Gr | 6 | | | | | | | | | 6 |
| Coating | Mix1 | Moist1 | Cal1 | Elyte1 | Coat2 | NMC/Gr | 6 | | | | | | | | | 6 |
| | Mix1 | Moist1 | Cal1 | Elyte1 | Coat3 | NMC/Gr | 6 | | | | | | | | | 6 |
| Calendaring | Mix1 | Moist1 | Cal2 | Elyte1 | Coat1 | NMC/Gr | 6 | | | | | | | | | 6 |
| | Mix1 | Moist1 | Cal3 | Elyte1 | Coat1 | NMC/Gr | 6 | | | | | | | | | 6 |
| Moisture/ | Mix1 | Moist2 | Cal1 | Elyte1 | Coat1 | NMC/Gr | 6 | | | | | | | | | 6 |
| Defects | Mix1 | Moist3 | Cal1 | Elyte1 | Coat1 | NMC/Gr | 6 | | | | | | | | | 6 |
| | Mix1 | Defect1 | Cal1 | Elyte1 | Coat1 | NMC/Gr | 6 | | | | | | | | | 6 |
| | Mix1 | Defect2 | Cal1 | Elyte1 | Coat1 | NMC/Gr | 6 | | | | | | | | | 6 |
| Electrolyte | Mix1 | Moist1 | Cal1 | Elyte2 | Coat1 | NMC/Gr | 6 | | | | | | | | | 6 |
| | Mix1 | Moist1 | Cal1 | Elyte3 | Coat1 | NMC/Gr | 6 | | | | | | | | | 6 |
| | Mix1 | Moist1 | Cal1 | Elyte4 | Coat1 | NMC/Gr | 6 | | | | | | | | | 6 |
| Chemistry | Mix1 | Moist1 | Cal1 | Elyte1 | Coat1 | LFP/Gr | 6 | | | | | | | | | 6 |
| | Mix1 | Moist1 | Cal1 | Elyte1 | Coat1 | NMC/GrSi | 6 | | | | | | | | | 6 |
| | Mix1 | Moist1 | Cal1 | Elyte1 | Coat1 | LFMP/Gr | 6 | | | | | | | | | 6 |
| | | | | | | Subtotal | 106 | 6 | 6 | 6 | 6 | 6 | 6 | 6 | 6 | |

Task 1.2: Equipment data extraction and upload into Manufacturing Execution System (MES). Identification, extraction, and MES integration of parameters for the electrode coater, calendaring, slurry mixer and humidity.
Task 1.3: Data integration from MES to cloud. Harmonize data across all battery manufacturing processes, including electrode parameters and formation cycling data.
Task 1.4: Build NMC/Graphite (NMC/Gr) pouch cells with process variability identified in Task 1.1 (see Table 2).
Task 1.5: Correlate formation features to upstream process parameters.
Task 1.6: Develop controller strategy enabling upstream process control via formation features.

Task 2: Formation Feature Design and Validation: Improve the formation fixture platform to enable enhanced sensing of formation features; expand the repertoire of formation features to improve the detectability of SEI quality; validate that the formation features are reliable indicators of SEI quality.
Task 2.1: Develop sensing platform enabling reliable thickness sensing and pressure control. We have shown that cell thickness is an important proxy to SEI quality [Ref. 2]. It is also known that pressure control is important for formation and subsequent lifetime [Ref. 20]. Finally, gas generation is another important SEI quality indicator [Ref. 7]. It is thus desirable to obtain thickness and gas measurements under controlled pressure conditions as a basis for developing physically relevant formation features. This task develops a low-cost fixture platform enabling these measurements.
Task 2.2: Expand the repertoire of formation features for NMC/Gr cells by at least 10. Include latest literature reports of formation features [Ref. 10,13]; explore data-driven approaches [Ref. 21] to developing formation features by processing the raw dataset without explicit feature engineering: dV/dQ (Ref [2]): Q⁺, Q⁻, NP Ratio, Qₛₑᵢ, x₀, y₀ (+6); SEI uniformity (Ref [10]): dV/dQ peak height, broadness, and skewness (+3); dQ/dV (Ref [13]): AG, whole-cell diffusion coefficient and Rot (+3); cell thickness expansion (+1); Gas expansion contribution to cell thickness (+1); electrochemical impedance spectroscopy (EIS) metrics: R₀ (ohmic resistance) and Rot (charge transfer resistance) (+2); moisture content and short resistance (+2), and data-driven formation features (+3).
Task 2.3: Verify the effect of upstream process variability on SEI quality. Cell samples having contrasting formation features (i.e., due to differences in upstream process variability) will be identified and analyzed for SEI quality. Higher throughput measurements, including optical analysis using 3-D digital microscopy and FTIR/XPS for chemical analysis, will be used to quantify SEI heterogeneity, mechanical damage, and composition. These analytical methods will be performed on at least 25 cells/year. Informed by these measurements, we will further down-select at least 10 cells/year for higher spatial resolution techniques including TEM, AFM, and/or SEM to further determine SEI thickness, composition, and mechanical properties [Ref. 15].
Task 2.4: Adapt feature extraction algorithms for multiple chemistries. The features from Task 2.2 and the work from Ref. [2], which focused on NMC/Gr systems, are expanded to additional relevant cell chemistries, specifically LFP/Gr, NMC/Gr+Si, and LMFP/Gr (where Gr=graphite), which are expected grow in importance in the future.

Task 3: Formation Protocol Optimization: Develop minimum-time formation protocols subject to physical constraints. The constraints may be set by the formation features (e.g. SEI quality, SEI heterogeneity, NP ratio) or by the internal variables of the formation process model (e.g. minimum anode potential, maximum anode expansion rate). Model development will be guided by experimental data which explores the effect of different formation protocols on formation features. We adopt a partial factorial design-of-experiments approach (see Table 2) to study sensitivities while maintaining a small sample space. Bayesian optimization approaches will also be considered to discover formation protocol parameters that most affect formation features. We also study the effect of formation protocol parameters on the formation feature signal quality, a necessary step towards understanding the generalizability of formation features towards different formation protocols.
Task 3.1: Build cells using standard material set (NMC/Gr, standard manufacturing process).
Task 3.2: Form the cells using different formation protocols. Generate experimental dataset to determine effect of different formation processes on formation features; knowledge will be used to guide development of optimal formation protocols and formation control concepts. See Table 2.
Task 3.3: Develop correlations between formation features and the formation protocol inputs. Analyze relationship between formation protocol parameters and the formation features using a combination of data-driven approaches and physics-based approaches; this knowledge is needed for developing optimal formation protocols and controllers. Effect of pressure, temperature, C-rate, voltage window.
Task 3.4: Verify the effect of different formation protocols on SEI quality metrics. See Task 2.3; the task scope here is the same, but applied to samples having different formation protocols.
Task 3.5: Quantify the effect of formation protocols on formation feature signal quality. Crucial to deployment in existing factories having unique formation protocols, this task analyzes the trade-offs between formation speed (i.e., protocol variations) and formation feature signal quality.
Task 3.6: Develop a formation protocol process model. Combine knowledge gained from Task 3.3 and Task 3.4 to augment the formation process model from Ref [12] with explicit representation of formation process parameters (temperature, pressure, etc.). Controllability analysis for >3 formation features.
Task 3.7: Develop minimum-time formation protocols subject to constraints. Propose real-time controller designs that minimize formation time while maintaining constraints based on formation feature or the formation model, e.g., minimum NP ratio; maximum electrode stress, minimum anode potential.

Task 4: Formation Feature (FF) Specifications Informed by Lifetime: Demonstrate the potential for formation features to set end-of-line specifications informed by long-term lifetime. To enable this, we will study the long-term effect of SEI quality, inferred via formation features, on lifetime under representative use cases. Then, formation feature spec limits will be developed to meet certain lifetime targets.
Task 4.1: Develop cycle life test profile. Since cell lifetime is highly dependent on use case [Ref. 21], it is necessary to design a real-world representative test profile in order for the lifetime outcomes to be relevant.
Task 4.2: Run cycling test campaign for cells built from Task 1.4. Cells built from Task 1.4 will be put on long-term cycle life testing in pressure-controlled fixtures. The cells will be cycled until capacity drops below 50%, or at the end of one year, whichever comes first. End-of-life performance metrics, including capacity, resistance, and formation feature-equivalent features, are extracted and analyzed.
Task 4.3: Run cycling test campaign for cells built from Task 3. Same as Task 4.2 but for cells built to study the effect of formation protocol variability on formation features.

### Example 2

### Introduction

In battery formation, the last step in battery manufacturing is painful. Battery formation is expensive as it is approximately 32% of total manufacturing costs. Battery formation is long as it can take about 1.5 to 3 weeks of storage space that is needed for millions of battery cells. Battery formation is energy intensive as it is about 27% of total energy consumption. However, battery formation provides an untapped source of electrochemical data that can improve cell performance diagnostics, upstream process control, and formation speed. Yet, data interpretation remains challenging without a model based understanding of the battery formation process.

### Modeling Formation

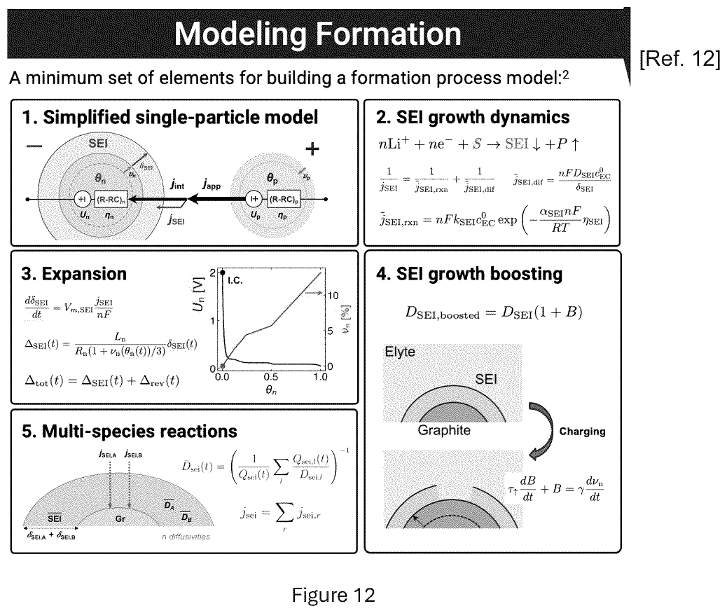

FIG. 12 shows a schematic of modeling battery formation. A minimum set of elements for building a formation process model is shown. Panel 1 of FIG. 12 shows a simplified single particle model. Panel 2 of FIG. 12 shows SEI Growth Dynamics. Panel 3 of FIG. 12 shows an expansion model. Panel 4 of FIG. 12 shows an SEI growth boosting model. Panel 5 of FIG. 12 shows a multi species reactions model.

### Smart Formation

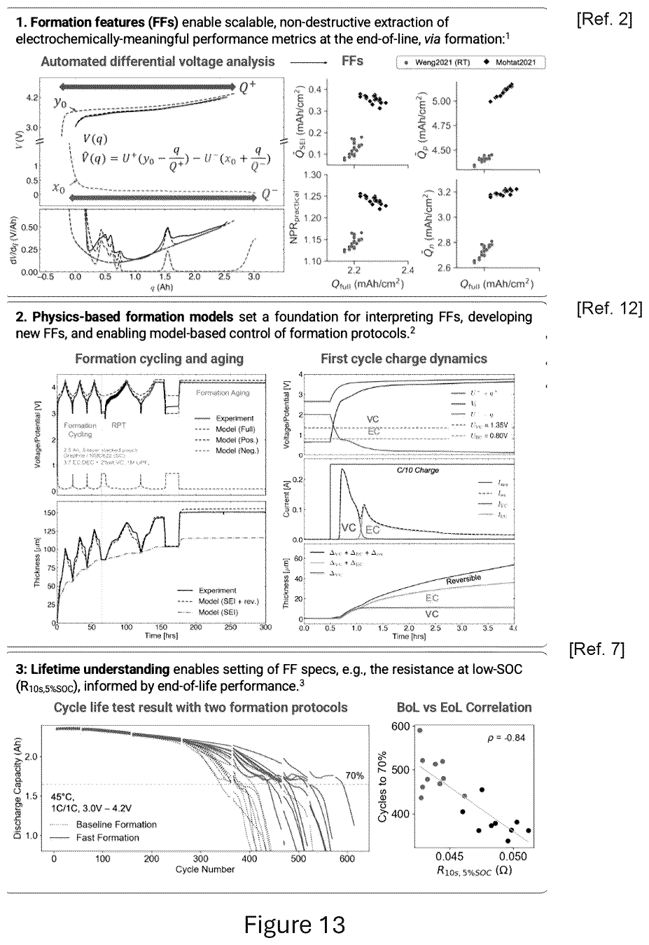

FIG. 13 shows the three pillars of smart formation. Panel 1 of FIG. 13 shows that formation features enable scalable non-destructive extraction of electrochemically meaningful performance metrics at the end-of-line via formation [Ref. 2]. Panel 2 of FIG. 13 shows that physics-based formation models can set a foundation for interpreting formation features, developing new formation features, and enabling model-based control of formation protocols [Ref. 12]. Panel 3 of FIG. 13 shows that lifetime understanding enables the setting of formation feature specifications for example the resistance at low state of charge (Rios, 5% soc) informed by end of life performance [Ref. 7].

### Model Validation

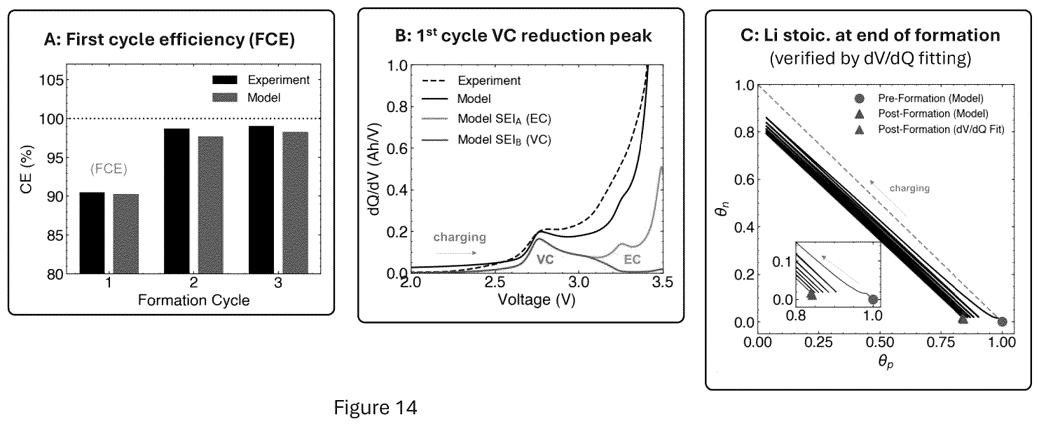

FIG. 14 shows model validation for non-limiting embodiments of the present disclosure. Panel A shows first cycle efficiency comparing a model and experimental data. Panel B shows first cycle vinylene carbonate (VC) reduction peak comparing models and experimental data. Panel C shows lithium stoichiometry at the end of formation verified by dV/dQ fitting.

### Lifetime Simulations

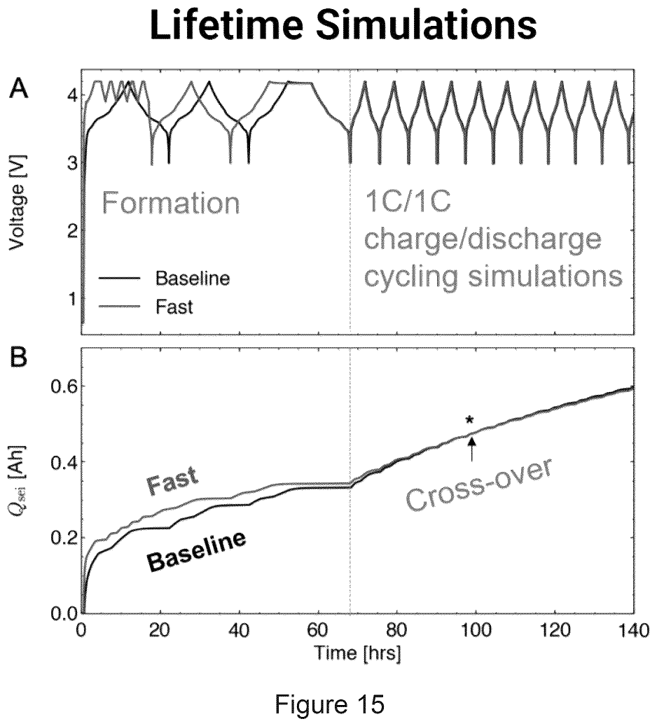

FIG. 15 shows lifetime simulations for non-limiting embodiments of the present disclosure. Every commercial lithium-ion battery undergoes formation cycling and aging at the end of the battery cell manufacturing process. The formation process is time and capital-intensive, motivating battery manufacturers to develop new formation protocols to decrease formation time while maintaining battery lifetime and safety. Without battery formation models, formation protocol optimization requires brute-force, trial-and-error approaches, which are slow, inefficient, and not guaranteed to yield optimal outcomes.

The main goal of battery formation is to form a passivating solid electrolyte interphase (SEI) layer at the negative electrode surface which limits further SEI growth over the battery's life. SEI growth occurs throughout the battery formation process which comprises both cycling and calendar aging steps. During formation cycling, the battery is externally charged and discharged for the first time following electrolyte filling (see FIG. 15). Formation cycling is followed by formation aging, during which the battery cells are stored at high temperatures and high states of charge (SOCs) for days to weeks to continue the SEI growth process and screen for quality defects.

The SEI reaction and film growth process is complex. Multiple reaction pathways are often involved since multiple electrolyte components, including solvents and additives, can participate simultaneously in the SEI reaction. The resulting SEI film is thus heterogeneous in composition. The SEI film is also difficult to study experimentally owing to the reactivity of the electrode-electrolyte interface and the nanometer thickness of the film. These inherent complexities of the SEI growth process partly explain why existing SEI growth models are difficult to parameterize and experimentally validate, hindering their applications in a battery manufacturing context for formation process design and lifetime prediction.

Despite the microscopic complexities of SEI growth, the battery formation process for commercial-scale cells yields electrochemical signals which can be directly measured using standard equipment during formation cycling. FIG. 15 shows example data that underwent three formation charge-discharge cycles, followed by reference performance tests (RPTs), followed by formation aging. For pouch cell form factors, thickness expansion can be directly measured using a sensor fixture [Ref. 11, Ref. 20, Ref. 22]. The measurements suggest that total cell expansion can be attributed to two distinct sources. The first source is due to changes in the lithium content (or stoichiometry) in the positive and negative electrode particles. During lithiation, the particles swell, and during delithiation, the particles contract. Since this process is reversible, we will refer to this source as “reversible expansion.” The reversible expansion tracks closely to the measured cell voltage, or state of charge (SOC), which determines the lithium content in either electrode. The second source of expansion can be noticed from the minimum expansion at the end of every discharge cycle. This expansion appears to always increase over cycles. We will thus refer to this expansion source as “irreversible expansion”. The irreversible expansion is attributed to the growth of the SEI layer during formation and aging. Consistent with the data of FIG. 15, the irreversible expansion is high during the first cycle, but then slows down over the next two cycles. During formation aging, the irreversible expansion rate appears to decrease, indicating a possibly slower SEI growth process compared to cycling. Thus, SEI growth rates in charge/discharge cycling can differ depending on whether a fast or slow formation charging protocol is used, and there can be a crossover point where the SEI growth rate after a slower formation charging protocol exceeds the SEI growth rate after a faster formation charging protocol (see FIG. 15).

### Battery Formation Controller Design

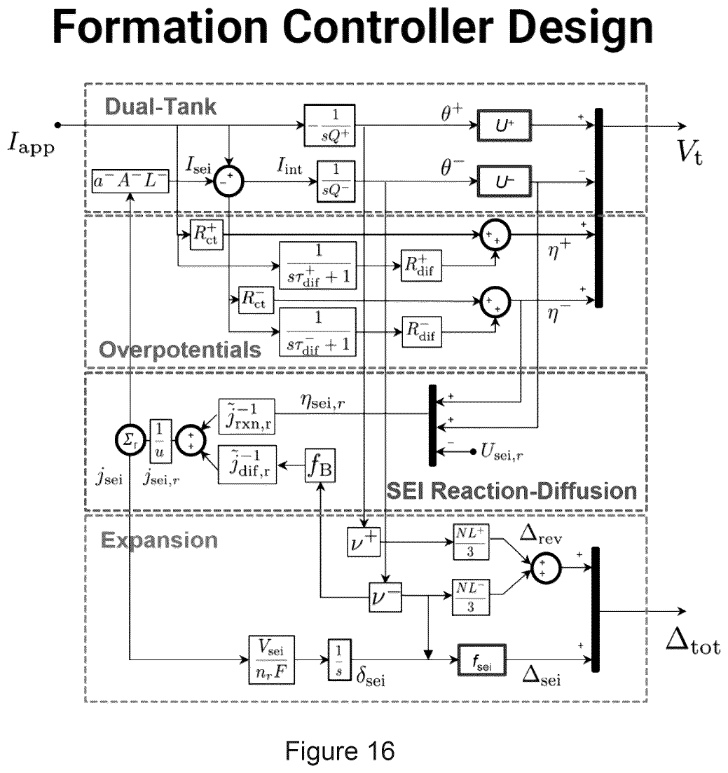

FIG. 16 shows a battery formation controller design for a non-limiting embodiment of the present disclosure. The general SEI reaction can be represented by:

$${nLi}^{+} + n {e}^{-} + S \to S E I ↓ + P ↑ ,$$

where S represents a solvent molecule, n is the number of participating electrons, ‘SEI’ stands for the newly-formed solid reduction product, and P denotes some reaction byproduct, usually a gas. Candidate solvent molecules include ethylene carbonate (EC) and diethyl carbonate (DEC). Note that S can also represent electrolyte additives such as vinylene carbonate (VC).

FIG. 16 shows a ‘dual-tank’ formation modeling framework. At the positive and negative electrode, the lithium stoichiometry θ⁺, θ⁻ is tracked and used to update the electrode equilibrium surface potentials U⁺, U⁻ and volumetric expansions v⁺, v⁻. The total applied current density Iₐₚₚ passes through the positive electrode. However, at the negative electrode, the current is split between the intercalation current density lint and the SEI current density Iₛₑᵢ. SEI build-up leads to SEI thickness growth, denoted by δₛₑᵢ.

In the model of FIG. 16, the negative electrode equilibrium surface potential, U⁻ provides the thermodynamic basis for SEI-forming reactions. However, U⁻ is not directly controllable or observable during the formation process in commercial devices. Rather, the terminal voltage, Vt, is observed and controlled. A practical model of battery formation therefore requires a description of Vt written as:

$${V}_{t =} {U}^{+} {θ}^{+} - {U}^{-} {θ}^{-} + {η}^{+} + {η}^{-}$$

where η⁺ and η⁻ are positive and negative electrode overpotentials. The electrode surface overpotentials are governed by charge-transfer kinetics at the electrode-electrolyte interface and solid-state diffusion dynamics where R_{ct}⁺ and R_{ct}⁻ are lumped resistance terms that include both series and charge-transfer resistance, and R_{dif}⁺ and R_{dif}⁻ represent solid-state diffusion resistance and where τ_{dif}⁺, and τ_{dif}⁻, are the diffusion time constants.

The SEI reaction current density is jₛₑᵢ and can be written in terms of a summation of two limiting currents:

$$\frac{1}{{\dot{J}}_{S E I , r}} = \frac{l}{{\tilde{J}}_{rxn , r}} + \frac{1}{{\tilde{J}}_{dif , r}} ,$$

where η_{SEI,r} is the SEI reaction overpotential and r is the number of electrons involved in the reaction, and U_{SEI,r} is the SEI reaction potential.

FIG. 16 also includes a concept called “SEI growth boosting”. Specifically, ƒ_{B} in FIG. 16 is a function that describes the process of boosted SEI growth during charging. The boosting refers to enhanced SEI growth rate during cell charging which has been previously explored in the context of degradation modeling. This effect is especially important to consider during formation cycling, during which the electrodes are experiencing the largest change in lithium stoichiometry. This stoichiometry change creates more particle-level strains which exposes new reaction surfaces, boosting the SEI growth rate. This model extension is for unifying the observed macroscopic formation trends during both formation cycling and formation aging. See Ref. 12.

A graphite particle starts at some initial state of lithiation θₙ=θ_{n,0}. As the full cell is charged, the graphite lithiates and expands. Ideally, the SEI elastically deforms to accommodate the particle swelling. However, if the SEI film is brittle, then parts of the SEI film may fracture, exposing fresh electrode surfaces to new electrolyte. Reacting molecules near these newly-exposed electrode surfaces will see more facile reaction kinetics since no pre-existing SEI film is present to limit the diffusion of reacting molecules to the reaction surface. The overall SEI current density will thus be temporarily boosted. See Ref. 12.

Next, we consider the case of delithiation and resting. During resting, new SEI is formed to fill in the fresh electrode surfaces. As the SEI thickness in these regions approach the volume-averaged thickness, the overall SEI reaction rate is restored to the rate prior to boosting. During delithiation, the SEI is assumed to remain in contact with the graphite particles which are contracting, so no new electrode surfaces are exposed. Note that this assumption may be violated by systems having high volumetric expansions such as silicon. Overall, during resting and discharging, we assume that boosting no longer occurs and the SEI growth rate is gradually restored to the original rate prior to boosting.

This Example interprets the SEI growth boosting process as a modification to the effective SEI diffusivity, D_{SEI}. In this interpretation, newly exposed electrode surfaces are represented as increases to the local SEI porosity which in turn increase the volume-averaged SEI porosity E. Changes in the volume-averaged porosity are represented by the effective diffusivity according to:

$${D}_{SEI} ( t ) = {D}_{SEI , 0} \frac{ε ( t )}{τ} ,$$

where D_{SEI} is the effective diffusivity, D_{SEI,0} is a reference diffusivity, E is the volume-averaged SEI film porosity, and T is the tortuosity. Note that this expression can be further simplified using the Bruggeman relation τ=ε^{-0.5}.

To describe the dynamics of the porosity evolution, we define an empirical “boost factor” B(t) which modifies the effective SEI diffusivity according to:

$${D}_{SEI , boosted} ( t ) = {D}_{SEI , 0} ( 1 + B ( t ) ) ,$$

where D_{SEI,boosted} is the boosted SEI diffusivity. We assume that the dynamics of boosting is described by some unknown function ƒ(B(t)) which is driven by the negative electrode expansion rate:

$$f ( B ( t ) ) = γ \frac{d {v}_{n} ( {θ}_{n} )}{dt} ,$$

where vₙ is the negative electrode volume expansion function and γ is an input sensitivity parameter. A first-order Taylor expansion of ƒ(B(t)) leads to our proposed state equation describing SEI growth boosting:

$$τ \frac{d B}{d t} + B = γ \frac{d {v}_{n}}{dt} .$$

In this equation, τ is the time constant for the first-order dynamics. This equation can be further separated for boosting during lithiation and “de-boosting” during delithiation and rest, with separate time constants describing each process:

$$\{ \begin{matrix}{τ}_{↑} \frac{d B}{dt} + B & = γ \frac{{dv}_{n}}{d t} & {I}_{a p p} > 0 & ( Boost ) \\ {τ}_{↓} \frac{d B}{dt} + B & = 0 & {I}_{a p p} \leq 0 & ( De - boost ) .\end{matrix}$$

During charging, the boosting time constant τ_{↑} describes how quickly the effective diffusivity increases in response to newly-created reaction surfaces for SEI growth. During discharging and resting, the de-boosting time constant τ_{↓} describes the rate of “self-healing” as the freshly-created surfaces fill up with new SEI and the effective diffusivity approaches its original value, D_{SEI,0}. See Ref. 12.

The SEI reaction current density, jₛₑᵢ, can be converted to total SEI current by:

$${I}_{SEI} = {a}^{-} {A}^{-} {L}^{-}$$

where a⁻ is the specific surface area (i.e. surface-to-area volume ratio) of the negative electrode, A⁻ is the geometric area of the negative electrode, and L⁻ is the geometric thickness of the negative electrode. The SEI current can then be directly integrated to yield the total capacity of lithium lost to SEI-forming reactions:

$${Q}_{SEI} = \int {I}_{S E I} ( t ) d t .$$

A representation of the total cell thickness expansion, Δₜₒₜ, can be of the form:

$${Δ}_{t o t} ( t ) = {Δ}_{s e i} ( t ) + {Δ}_{r e v} ( t )$$

The first term Δₛₑᵢ₍ₜ₎, represents the irreversible cell thickness expansion due to SEI film growth and is given by:

$${Δ}_{SEI} ( t ) = \frac{{N}_{layers} {L}_{n}}{{R}_{n} ( 1 + {v}_{n} ( {θ}_{n} ( t ) ) / 3 )} {δ}_{SEI} ( t )$$

where δ_{SEI} is SEI film thickness at a negative electrode particle, Lₙ is the geometric length of the negative electrode, and N_{layers} is the number of active layers in the stacked configuration. Rₙ is the radius of a single negative electrode particle, θₙ is lithium stoichiometry, and vₙ is the reversible expansion function of the negative electrode.

The SEI film thickness, δ_{SEI}, evolves due to the accumulation of SEI current:

$$\frac{d {δ}_{SEI}}{dt} = {V}_{S E I} \frac{{j}_{SEI}}{n F} .$$

where V_{SEI} is the SEI molar volume in m³/mol.

The second term, Δᵣₑᵥ(t), represents the reversible expansion of the positive and negative electrodes, and is given by:

$${Δ}_{r e v} ( t ) = {v}^{+} {N}_{layers} {L}^{+} / 3 + {v}^{-} {N}_{layers} {L}^{-} / 3$$

where v⁺ and v⁻ are the volumetric expansion functions for each electrode.

In FIG. 16, ƒₛₑᵢ is:

$${Δ}_{SEI} ( t ) = \frac{{N}_{layers} {L}_{n}}{{R}_{n} ( 1 + {v}_{n} ( {θ}_{n} ( t ) ) / 3 )} {δ}_{SEI} ( t ) ,$$

where δ_{SEI} is SEI film thickness at a negative electrode particle, Lₙ is the geometric length of the negative electrode, and N_{layers} is the number of active layers in the stacked configuration. Rₙ is the radius of a single negative electrode particle and vₙ is the reversible expansion function of the negative electrode. See Ref. 12. Advantageously, ƒₛₑᵢ describes how to convert microscopic, particle-level expansion to macroscopic, pouch cell-level total expansion, using geometrical prefactors (e.g., number of electrode layers, electrode thickness, particle radius), and accounts for reversible, lithiation-induced expansion (with the term vₙ(θₙ(t)).

The formation model of FIG. 16 can be used to simulate both the formation process and subsequent battery lifetime (i.e., cycle life) within a single, self-consistent framework. Thus, the model enables the evaluation of the long-term impact of formation protocols. FIG. 16 shows that the formation model predicted that a fast formation protocol consumed more SEI during formation (Qₛₑᵢ); however, the same formation protocol decreased the SEI consumption rate during subsequent cycling, leading to an overall improved cycle life.

The model of FIG. 16 can be part of a program that is stored and executed in a manufacturing process controller. This can provide a number of advantages including, without limitation: (1) closed-loop control of upstream process parameters subject to formation feature constraints, (2) development of minimum-time formation protocols while maintaining formation feature target specifications such as an SEI thickness that improves cycle life, and (3) setting smart formation feature specification limits informed by battery lifetime understanding.

The controller can input signals based on one or more of the formation features into a trained machine learning model, wherein the trained machine learning model is trained on the signals based on the one or more of the formation features. The trained machine learning model can be further trained on additional signals based on one or more of the formation features. Training can include consideration of: (i) battery formation times; (ii) SEI thickness; and (iii) electrode and electrolyte chemistry.

### REFERENCES

[1] Schomburg et al., “Lithium-ion battery cell formation: status and future directions towards a knowledge-based process design”, Energy Environ. Sci., 2024, 17, 2686-2733.
[2] Weng et al., “Differential voltage analysis for battery manufacturing process control,” Front. Energy Res., 2023, 11.
[3] An et al., “Fast Formation Cycling for Lithium Ion Batteries,” Journal of Power Sources, 2018, 342, 846-52.
[4] Drees et al., “Fast Charging Formation of Lithium-Ion Batteries Based on Real-Time Negative Electrode Voltage Control”, Energy Technol., 2023, 11.
[5] Attia et al., “Battery quality at scale,” arXiv, 2024, 2403.01065.
[6] Dan Heath, “Upstream, The Quest to Solve Problems Before They Happen,” Simon & Schuster 2020.
[7] Weng et al., “Predicting the impact of formation protocols on battery lifetime immediately after manufacturing,” Joule, 2021, 5(11), 2971-2992.
[8] Jing et al., “2023 Battery Report,” Volta Foundation, 2024.
[9] Degen et al., “Energy consumption of current and future production of lithium-ion and post lithium-ion battery cells”, Nat. Energy, 2023, 8(11) 1284-95.
[10] Wong et al., “Differential Voltage Analysis and Patterns in Parallel-Connected Pairs of Imbalanced Cells,” 2024 American Control Conference (ACC), Toronto, ON, Canada, 2024, pp. 3492-3497.
[11] Pannala et al., “Low-cost inductive sensor and fixture kit for measuring battery cell thickness under constant pressure”, IFAC-PapersOnLine 55.37 (2022): 712-717.
[12] Weng et al., “Modeling Battery Formation: Boosted SEI Growth, Multi-Species Reactions, and Irreversible Expansion”, Journal of The Electrochemical Society 2023, 170(090523)
[13] Wood et al., “Extracting Thermodynamic, Kinetic, and Transport Properties from Batteries Using a Simple Analytical Pulsing Protocol”, Journal of The Electrochemical Society 171.8 (2024): 080501.
[14] Krusemark et al., “Examining Workforce Needs for North America: BIETNA,” Center for Auto. Res., 2024.
[15] Kazyak et al., “Enabling 4C fast charging of lithium-ion batteries by coating graphite with a solid-state electrolyte”, Advanced Energy Materials 12.1 (2022): 2102618.
[16] Ngandjong et al., “Investigating electrode calendering and its impact on electrochemical performance by means of a new discrete element method model: Towards a digital twin of Li-Ion battery manufacturing”, Journal of Power Sources 485 (2021): 229320.
[17] Sulzer et al., “Accelerated Battery Lifetime Simulations Using Adaptive Inter-Cycle Extrapolation Algorithm,” Journal of The Electrochemical Society, 2021, 168 (12), 120531.
[18] Pannala et al., “Consistently tuned battery lifetime predictive model of capacity loss, resistance increase, and irreversible thickness growth”, Journal of The Electrochemical Society 171.1 (2024): 010532.
[19] Sulzer et al., “The challenge and opportunity of battery lifetime prediction from field data”, Joule 5.8 (2021): 1934-1955.
[20] Mohtat et al., “Reversible and irreversible expansion of lithium-ion batteries under a wide range of stress factors”, Journal of The Electrochemical Society 168.10 (2021): 100520.
[21] Severson et al., “Data-driven prediction of battery cycle life before capacity degradation”, Nature Energy 4.5 (2019): 383-391.
[22] Mohtat et al., “On identifying the aging mechanisms in Li-ion batteries using two points measurements,” 2017 American Control Conference (ACC), Seattle, WA, USA, 2017, pp. 98-103.

The citation of any document or reference is not to be construed as an admission that it is prior art with respect to the present invention.

Thus, the invention provides a platform for electrochemical feature extraction during battery formation such that these features can be used to develop smarter upstream process specifications.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in some embodiments”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

1. A method for manufacturing an electrochemical cell including an anode, an electrolyte, and a cathode including cations that move from the cathode to the anode during a charging phase, the method comprising:
(a) obtaining a measurement of an electrochemical feature at a selected time in a formation charging phase for creating the electrochemical cell from a cell structure, wherein the electrochemical feature is other than capacity, resistance, and voltage decay; and
(b) maintaining or adjusting, based on the measurement of the electrochemical feature, at least one process parameter of a manufacturing process selected from: a production process for an anode of a later-produced electrochemical cell, a production process for a cathode of the later-produced electrochemical cell, an assembly process for a cell structure of the later-produced electrochemical cell, a filling process for an electrolyte of the later-produced electrochemical cell, and a formation charging process of the later-produced electrochemical cell.

2. The method of claim 1 wherein:
step (b) comprises maintaining or adjusting, based on the measurement of the electrochemical feature, at least one process parameter of a production process for an anode of the later-produced electrochemical cell.

3. The method of claim 1 wherein:
step (b) comprises maintaining or adjusting, based on the measurement of the electrochemical feature, at least one process parameter of a production process for a cathode of the later-produced electrochemical cell.

4. The method of claim 1 wherein:
step (b) comprises maintaining or adjusting, based on the measurement of the electrochemical feature, at least one process parameter of an assembly process for a cell structure of the later-produced electrochemical cell.

5. The method of claim 1 wherein:
step (b) comprises maintaining or adjusting, based on the measurement of the electrochemical feature, at least one process parameter of a filling process for an electrolyte of the later-produced electrochemical cell.

6. The method of claim 1 wherein:
step (b) comprises maintaining or adjusting, based on the measurement of the electrochemical feature, at least one process parameter of a formation charging process of the later-produced electrochemical cell.

7. The method of claim 1 wherein:
step (b) comprises maintaining or adjusting the at least one process parameter based on a physics-based model that uses the measurement of the electrochemical feature.

8. The method of claim 1 wherein:
the physics-based model is a solid electrolyte interphase growth model.

9. The method of claim 8 wherein:
the physics-based model comprises a trained machine learning model that is trained on a signal based on the electrochemical feature.

10. (canceled)

11. (canceled)

12. (canceled)

13. The method of claim 1 wherein:
the electrochemical feature is at least one of: positive capacity ratio (NPR), solid electrolyte interphase (SEI) density, SEI thickness, cations consumed during formation (Q_{SEI}), anode loading (Q⁻), cathode loading (Q⁺), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (Rot) from Electrochemical Impedance Spectroscopy (EIS), short resistance, Gibbs free energy, whole-cell lithium-ion diffusion coefficient, exchange current density, gas volume, and water content.

14. The method of claim 1 wherein:
the electrochemical feature is negative to positive capacity ratio (NPR).

15. The method of claim 1 wherein:
the electrochemical feature is cations consumed during formation (Q_{SEI}).

16. The method of claim 1 wherein:
the electrochemical feature is anode loading (Q⁻).

17. The method of claim 1 wherein:
the electrochemical feature is cathode loading (Q⁺).

18. (canceled)

19. (canceled)

20. (canceled)

21. (canceled)

22. (canceled)

23. (canceled)

24. (canceled)

25. (canceled)

26. (canceled)

27. (canceled)

28. A method for manufacturing an electrochemical cell including an anode, an electrolyte, and a cathode including cations that move from the cathode to the anode during a charging phase, the method comprising:
(a) obtaining a measurement of an electrochemical feature at a selected time in a formation charging phase for creating the electrochemical cell from a cell structure, wherein the electrochemical feature is other than capacity, resistance, and voltage decay; and
(b) detecting or ruling out a manufacturing defect, based on the measurement of the electrochemical feature.

29. (canceled)

30. (canceled)

31. (canceled)

32. The method of claim 28 wherein:
the electrochemical feature is at least one of: positive capacity ratio (NPR), solid electrolyte interphase (SEI) density, SEI thickness, cations consumed during formation (Q_{SEI}), anode loading (Q⁻), cathode loading (Q), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (Rot) from Electrochemical Impedance Spectroscopy (EIS), short resistance, Gibbs free energy, whole-cell lithium-ion diffusion coefficient, exchange current density, gas volume, and water content.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. A method for predicting end of life of an electrochemical cell including an anode, an electrolyte, and a cathode including cations that move from the cathode to the anode during a charging phase, the method comprising:
(a) obtaining a measurement of an electrochemical feature at a selected time in a formation charging phase for creating the electrochemical cell from a cell structure, wherein the electrochemical feature is other than capacity, resistance, and voltage decay; and
(b) determining end of life of the electrochemical cell based on the measurement of the electrochemical feature.

45. The method of claim 44 wherein:
the electrochemical feature is at least one of: positive capacity ratio (NPR), solid electrolyte interphase (SEI) density, SEI thickness, cations consumed during formation (Q_{SEI}), anode loading (Q⁻), cathode loading (Q′), anode cation stoichiometry at 0% state of charge (x₀), cathode cation stoichiometry at 0% state of charge (y₀), cell thickness, homogeneity metrics, dQ/dV metrics, ohmic resistance (R₀) from Electrochemical Impedance Spectroscopy (EIS), charge transfer resistance (Rot) from Electrochemical Impedance Spectroscopy (EIS), short resistance, Gibbs free energy, whole-cell lithium-ion diffusion coefficient, exchange current density, gas volume, and water content.

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. A system for manufacturing an electrochemical cell including an anode, an electrolyte, and a cathode including cations that move from the cathode to the anode during a charging phase, the system comprising:
a sensor that generates signals from measurement of an electrochemical feature at a selected time in a formation charging phase for creating the electrochemical cell from a cell structure, wherein the electrochemical feature is other than capacity, resistance, and voltage decay; and
a controller in electrical communication with the sensor, the controller executing a program stored in the controller to:
(i) receive the signals from measurement of the electrochemical feature, and
(ii) maintain or adjust, based on the signals, at least one process parameter of a manufacturing process selected from: a production process for an anode of a later-produced electrochemical cell, a production process for a cathode of the later-produced electrochemical cell, an assembly process for a cell structure of the later-produced electrochemical cell, a filling process for an electrolyte of the later-produced electrochemical cell, and a formation charging process of the later-produced electrochemical cell.

58. (canceled)

59. (canceled)

60. (canceled)

61. (canceled)

62. (canceled)

63. (canceled)

64. (canceled)

65. A system for manufacturing an electrochemical cell including an anode, an electrolyte, and a cathode including cations that move from the cathode to the anode during a charging phase, the system comprising:
a sensor that generates signals from measurement of an electrochemical feature at a selected time in a formation charging phase for creating the electrochemical cell from a cell structure, wherein the electrochemical feature is other than capacity, resistance, and voltage decay; and
a controller in electrical communication with the sensor, the controller executing a program stored in the controller to:
(i) obtain a measurement of an electrochemical feature at a selected time in a formation charging phase for creating the electrochemical cell from a cell structure, wherein the electrochemical feature is other than capacity, resistance, and voltage decay; and
(ii) detect or rule out a manufacturing defect, based on the signals.

66. (canceled)

67. (canceled)

68. (canceled)

69. (canceled)

70. (canceled)

71. (canceled)

72. (canceled)
